(19) United States
(12) Patent Application Publication
(10) Pub. No.: US 2024/0389687 A1
(43) Pub. Date: Nov. 28, 2024

(54) THREE DIMENSIONAL MOLDS FOR LIQUID SPRAY DEPOSITION, AND METHODS AND SYSTEMS FOR CREATING ARTICLES OF APPAREL USING SAME

(71) Applicant: Nike, Inc., Beaverton, OR (US)

(72) Inventors: Paul Aznar, Beaverton, OR (US); Daniel P. Morgan, Beaverton, OR (US)

(73) Assignee: Nike, Inc., Beaverton, OR (US)

(21) Appl. No.: 18/674,475

(22) Filed: May 24, 2024

Related U.S. Application Data
(60) Provisional application No. 63/504,656, filed on May 26, 2023.

(51) Int. Cl. A41C 3/12; A41C 3/00; A41C 5/00; B29C 41/08

(52) U.S. Cl. CPC A41C 3/12; A41C 3/0057; A41C 5/005; B29C 41/08

(57) ABSTRACT

Three-dimensional molds for use in liquid spray deposition techniques, and methods and systems for manufacturing articles of apparel using the same are provided. In one aspect, the three-dimensional molds comprise a base surface and a plurality of protrusions. Each protrusion extends from the base surface to a tip or an edge of the respective protrusion, and each tip or edge forms an overhang over the base surface such that the article of apparel includes a plurality of openings corresponding to the plurality of overhangs formed by the plurality of protrusions. In another aspect, the methods of manufacturing an article of apparel comprises depositing a first layer of a first liquid material onto a three-dimensional mold including a plurality of openings and drying or curing the first liquid material on the three-dimensional mold to form the article of apparel.

### CROSS-REFERENCE TO RELATED APPLICATION

This application claims priority under 35 U.S.C. § 119 (e) to Provisional U.S. Patent Application No. 63/504,656, filed May 26, 2023, the disclosure of which is hereby incorporated by reference in its entirety.

### FIELD

The present embodiments relate generally to three dimensional molds for use in liquid spray deposition techniques, and in particular to three dimensional molds designed for certain properties in a resulting article of apparel.

### BACKGROUND

This section provides background information related to the present disclosure which is not necessarily prior art.

Garments and/or fabric swatches may be made by spraying a liquid material, such as a liquid latex, on top of a surface or mold. The liquid material may be sprayed using a spray gun or aerosol can to quickly create a non-woven fabric. The liquid material may be allowed to dry or cure to be used for clothing or other applications that use cloth, fabric, etc. Loose fibers may also be used during the process to provide a fabric appearance and feel. Spraying liquid material on top of upright fibers may result in a web-like layer. Spray intensity and/or droplet size may also be controlled.

### BRIEF DESCRIPTION OF THE DRAWINGS

The embodiments can be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIGS. 1A and 1B illustrate an exemplary liquid spray deposition system according to aspects disclosed herein.

FIG. 2 illustrates an exemplary mold configured to be used with the liquid spray deposition system of FIG. 1 and a resulting article of apparel.

FIG. 3 illustrates an exemplary mold configured to be used with the liquid spray deposition system of FIG. 1.

FIGS. 4A-4D illustrate an exemplary article of apparel created using the three-dimensional mold of FIG. 3.

FIGS. 5A-5C illustrate an exemplary mold having overhangs and configured to be used with the liquid spray deposition system of FIG. 1.

FIG. 6 illustrates an exemplary article of apparel formed using a mold having overhangs using the liquid spray deposition system of FIG. 1.

FIGS. 7A and 7B illustrate exemplary shoe upper formed using a mold having overhangs.

FIGS. 8A and 8B illustrate an exemplary three-dimensional lattice-shaped mold configured to be used with the liquid spray deposition system of FIG. 1.

FIG. 9 illustrates an exemplary portion of an article of apparel created using a first mold and a second mold with the liquid spray deposition system of FIG. 1.

FIG. 10 illustrates an exemplary article of apparel having a first layer and a second layer and created using the liquid spray deposition system of FIG. 1.

FIG. 11 illustrates an exemplary article of apparel having a first layer and a second layer and created using the liquid spray deposition system of FIG. 1.

FIG. 12 illustrates an exemplary article of apparel including a plurality of openings and a plurality of projections and created using the liquid spray deposition system of FIG. 1.

FIGS. 13A through 13O illustrate exemplary garments and articles of apparel that may be used using the liquid spray deposition system of FIG. 1.

FIG. 14 shows an exemplary method of forming an article of apparel to have a plurality of openings using a three-dimensional mold, according to aspects disclosed herein.

FIG. 15 shows an exemplary method of forming an article of apparel to have a plurality of openings using a three-dimensional mold having overhangs, according to aspects disclosed herein.

FIG. 16 shows an exemplary method of forming an article of apparel that is reinforced, according to aspects disclosed herein.

FIGS. 17A through 17L are images of three-dimensional molds that may be used using the liquid spray deposition system of FIG. 1.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope of those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

In the discussion that follows, terms “about,” “approximately,” “substantially,” and the like, when used in describing a numerical value, denote a variation of +/−10% of that value, unless specified otherwise.

Examples of the present disclosure relate to, among other things, articles of footwear having a sole structure. In one example, the articles of footwear may improve performance of a user. Each of the examples disclosed herein may include one or more of the features described in connection with any of the other disclosed examples. Examples of the present disclosure may incorporate cushioning elements into a sole structure while maintaining an overall height of an article of footwear relatively low/short.

As used herein, the term “garment” may refer to a discrete or complete item of clothing, product, or apparel that is worn (e.g., a sports bra), while the term “article of apparel” is intended to encompass articles worn by a wearer, which can also be referred to as “wearable articles”. Wearable articles can include, among other things, upper-body garments (e.g., bra, sports bra, tops, t-shirts, pullovers, hoodies, jackets, coats, vests, and the like), lower-body garments (e.g., pants, shorts, tights, capris, unitards, and the like), hats, gloves, sleeves (e.g., arm sleeves, calf sleeves), articles of footwear (e.g., uppers for shoes), and the like. The term “article of apparel” may also broadly refer to articles used in apparel, including to create a garment (e.g., loft and/or insulation used to create a jacket, etc.). A garment may be a type of article of apparel.

Typically, when an article of apparel is formed using liquid polymer material and/or prior liquid spray deposition techniques, the resulting article of apparel possesses low breathability, air permeability, and/or ventilation, decreasing the comfort of the wearer. As will be discussed in further detail below, the molds of the present disclosure are capable of facilitating ventilation and/or providing breathability and/or air permeability in predetermined areas of resulting articles of apparel where ventilation, breathability, or air permeability might otherwise may be difficult to achieve using prior techniques. Without wishing to be bound by any theory, these desirable properties may be achieved by providing one or more features (e.g., contour, pattern, texture, etc.) on at least one surface of the mold. That is, due to the orientation, size, shape, density, position, amount, etc. of the one or more three-dimensional components, the molds of the present disclosure are capable of producing articles of apparel having one or more openings and/or apertures in predetermined areas, of which provide desirable properties, such as ventilation, breathability, air permeability, etc.

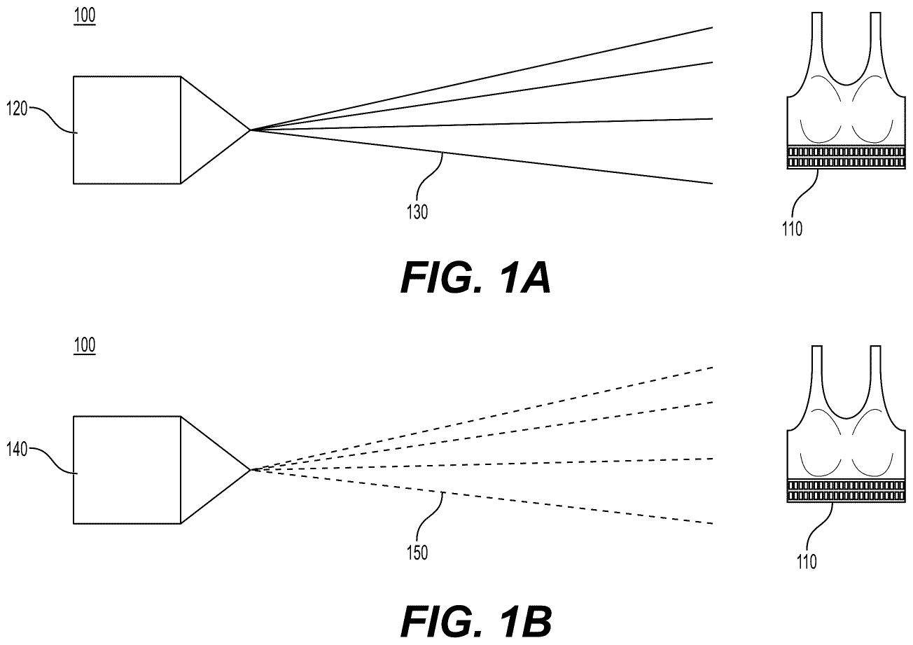

FIGS. 1A and 1B illustrate an exemplary liquid spray deposition system 100 according to aspects disclosed herein. Referring to FIG. 1A, the liquid spray deposition system 100 may include a mold 110 and a first nozzle 120 configured to deposit (e.g., spray) a liquid material 130 (e.g., polymer material) toward the mold 110. The mold 110 may be manufactured using any suitable technique or method known in the art (e.g., injection molding, casting, extruding, additive manufacturing, and the like).

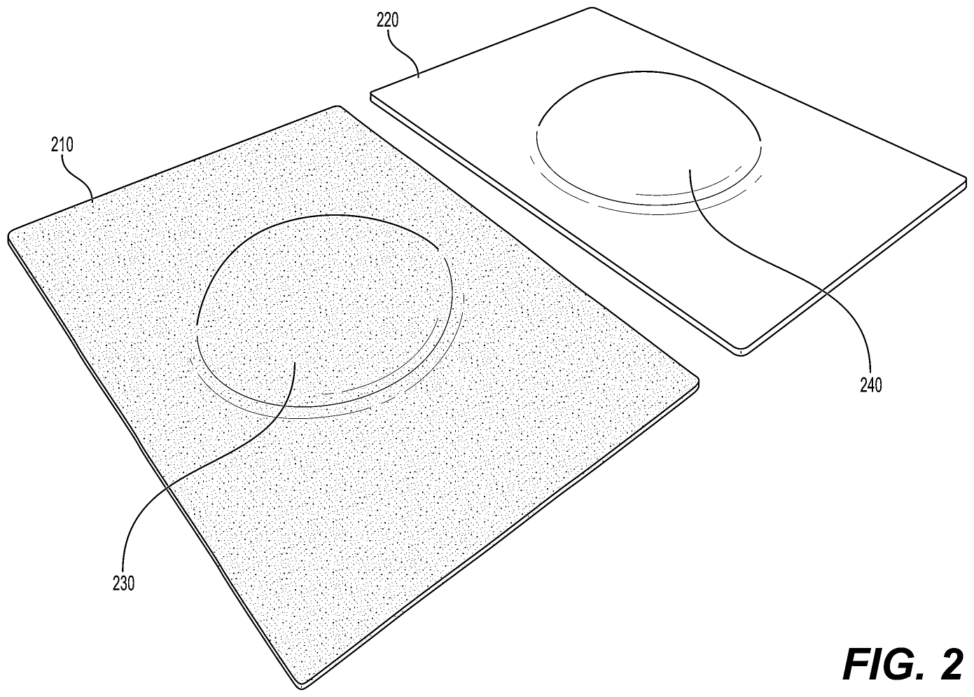

The mold 110 may have at least one three-dimensional component (e.g., contour and/or texture). For example, the mold 110 may have a shape and/or contour that corresponds to a shape of a resulting article of apparel or garment (e.g., a sports bra, as exemplified in FIG. 1). Alternatively or in addition thereto, the mold 110 may include a three-dimensional pattern and/or texture configured to produce certain features in the resulting article of apparel. Details on the mold 110 will be described with reference to FIGS. 2-12. During spraying, the mold 110 may be held upright by a support (e.g., wall or beam) and/or laid flat on a surface (e.g., table).

The first nozzle 120 may be part of a sprayer, spray gun, or other spray equipment configured to dispense and/or spray liquid. For example, the liquid spray deposition system 100 may include sprayer systems disclosed in U.S. U.S. Pat. No. 7,767,133 issued Aug. 3, 2010, which is incorporated by reference herein in its entirety. The liquid spray deposition system 100 may include air assisted based, airless based, electrostatic-based sprayers. In addition to the spray gun, these sprayers or sprayer systems may further include compressors, pressure tanks, pressure regulators, feeding pipes and other components known in the art for straying liquid polymers, elastomers such as latex, and other like materials. Representative dedicated airless guns for spraying liquid latex are commercially available for Graco N.V. of Belgium and by Spraying Systems Co. of IL, USA. The sprayer or sprayer system may consist of a single product material spray gun or may include additional spray guns for a variety of purposes such as creating different widths of spray bands, for spraying different compositions such as wetting agents or adhesives or for delivering different materials such as colored materials or agents or loose fibers. The spray guns preferably have a variable fan facility to enable the creation of thicker bands or layers of product material at desired areas. Aspects disclosed herein are not limited to a type of spray equipment used to spray the liquid material 130.

The liquid material 130 may be configured to be a solid when dried (e.g., cured using heat, allowed to dry at room temperature, dried using air, etc.). As disclosed in U.S. Pat. No. 7,767,133 issued Aug. 3, 2010, the liquid material 130 may include natural or synthetic polymers. A natural polymer may include latex rubber. A synthetic polymer may include polyurethane. For spraying purposes, emulsions, suspensions, or solutions of the product material, e.g., liquid latex rubber, may be used. After spraying the product material, with or without additional process steps, the liquid material 130 may be allowed to dry before it is removed from a surface of the mold 110. The drying process may include curing or setting processes, depending on a choice of product material. For example, when latex rubber is used as the product material, the latex rubber may cure as it dries. As disclosed in U.S. Patent Publication No. 2004/0153041 published Aug. 5, 2004, which is incorporated by reference herein in its entirety, the liquid material may include natural and artificial elastomers. Non-limiting examples of synthetic elastomers include polyisobutylene, isobutylene-isoprene copolymer (butyl elastomer), polyvinyl acetate, polyisoprene, polyethylene, vinyl acetate-vinyl laurate copolymers having vinyl laurate contents of about 5% to about 50% by weight of the copolymer, neoprene (polychloroprene), thermoplastic elastomers, nitrile rubber, synthetic latex (which has no proteins), styrenic elastomers, polyurethane, and silicone rubber, and combinations thereof. Non-limiting examples of natural elastomers include natural rubber such as smoked or liquid latex and guayule, and combinations thereof.

Referring to FIG. 1B, the liquid spray deposition system 100 may optionally include a second nozzle 140 configured to deposit and/or discharge a plurality of fibers 150 toward the mold 110. As disclosed in U.S. Pat. No. 7,767,133 issued Aug. 3, 2010, the second nozzle 140 may be part of a flocking machine. The flocking machine may be used independently of a sprayer system and/or first nozzle 130 used for spraying materials, but aspects disclosed herein are not limited. The flocking machine may be a pneumatic, electrostatic or combined flocking machine suitable for flocking natural or synthetic loose fibers over wet surfaces. Aspects disclosed herein are not limited to a type of equipment used to deposit the plurality of fibers 150. For example, U.S. Pat. No. 9,545,755 issued Jan. 17, 2017, which is incorporated by reference herein in its entirety, discloses a motorized moving ‘appliance’ head(s) used for applying different liquid based materials and polymers, motorized movable fibers flocking head(s) or unit(s), polymer curing system heating or drying elements or water evaporation system, material storage containers, etc. U.S. Pat. No. 8,840,969 issued Sep. 23, 2014, which is incorporated by reference herein in its entirety, discloses a flocking machine to adjust a relative movement of the flocked fibers.

As disclosed in U.S. Pat. No. 7,767,133 issued Aug. 3, 2010 and U.S. Pat. No. 7,901,740 issued Mar. 8, 2011, which are incorporated by reference herein in their entireties, the plurality of fibers 150 may include a natural and/or synthetic material. The plurality of fibers 150 may be hydrophilic, hydrophobic, or a combination of the two. Hydrophilic fibers may include wettable fibers or hydrophobic fibers that have been treated with a wetting agent to render them hydrophilic, absorbent fibers, and/or superabsorbent polymer fibers. Examples of wettable fibers may include bicomponent fibers, polypropylene fibers, and polyester fibers that have been treated for example with surfactants. Wettable fibers may include polyester fibers, such as DuPont-Akra Polyester Type 11A Bright commercially available from DuPont Company treated with a surfactant such as Tween 20 commercially available from ICI Americas Inc. Absorbent fibers may include hydrophilic fibers. Absorbent fibers may comprise rayon fibers, acrylic fibers, nylon fibers, polyvinyl alcohol fibers, and fibers of natural or regenerated cellulosics. An example of an absorbent fiber is rayon fibers. Superabsorbent polymer fibers may include hydrophilic fibers that are swellable and capable of absorbing greater than about 5 grams per gram (of fiber weight) of 1% saline solution. Examples of superabsorbent polymer fibers are polyacrylate fibers, fibers of grafted cellulose, and fibers of maleic acid. Examples of superabsorbent polymer fibers include OASIS Type 101, commercially available from Technical Absorbents Limited and CAMELOT, commercially available from Camelot, Alberta, Canada. The plurality of fibers 150 may include cotton fibers. Any suitable method for delivering the loose fibers so that they may be applied to the surface can be used. For instance, the loose fibers can be sprayed or blown as well as electrostatically and or pneumatically flocked. As disclosed in U.S. Patent Publication No. 2016/0096190, published Apr. 7, 2016, which is incorporated by reference herein in its entirety, the plurality of fibers 150 may include cotton, viscose, polyamide, polyester, wool, silk, metal, plastic, glass, rubber, SAF, and any other suitable fibers. The plurality of fibers 150 may be approximately 0.2 to 20 mm long.

The second nozzle 140 may deposit the plurality of fibers 150 before and/or after the liquid material 130 is sprayed. For example, the liquid spray deposition system 100 may include equipment (e.g., sprayers, nozzles, etc.) configured to apply a wetting agent onto a surface, spray loose fibers onto at least a portion of a wetted surface, and spray liquid product material onto at least a portion of the fiber coated surface, as disclosed in U.S. Pat. No. 7,767,133 issued Aug. 3, 2010. As disclosed, the wetting agent may include water or any suitable aqueous solution, e.g., a surfactant solution, prior to the application of the loose fibers. The wetting agent may not interfere with the flocking procedure or cause any degradation of the product material layer. In addition, loose fibers may be further applied. However, aspects disclosed herein are not limited to an order and/or sequence of applying liquid material 130, the plurality of fibers 150, and/or any other material (e.g., wetting agent, adhesive material, etc). In addition, dried layers of the liquid material 130 and/or the plurality of fibers 150 may be flipped over to apply one or more layers of the liquid material 130 and/or the plurality of fibers 150 to an opposite side of the dried layer.

FIG. 2 illustrates an exemplary mold 210 configured to be used with the liquid spray deposition system 100 and a resulting article of apparel or swatch 220. Referring to FIG. 2, the mold 210 may be a rigid material (e.g., plastic, ceramic, metal, etc.) and may include a three-dimensional contour, such as by including one or more protrusions 230 (e.g., one or more semi-spheres). After liquid material 130 and/or the plurality of fibers 150 (FIG. 1) are applied to the mold 210, the resulting article of apparel 220 may have a contour that corresponds to that of the mold 210, including one or more protrusions 240 that correspond to the one or more protrusions 230 of the mold 210. Although a concave protrusion 230 could be used to produce a convex protrusion 240 in the article of apparel, the protrusions 230 of the mold 210 may be convex to protrude toward the first nozzle 120 and/or the second nozzle 140 (FIG. 1) to reduce pooling of the liquid material 130 after application.

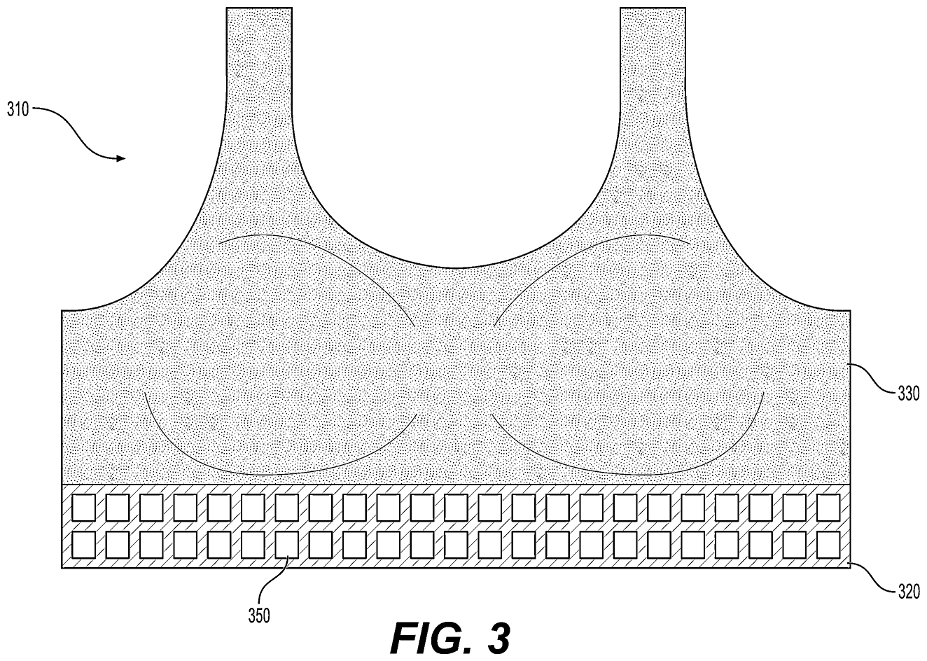

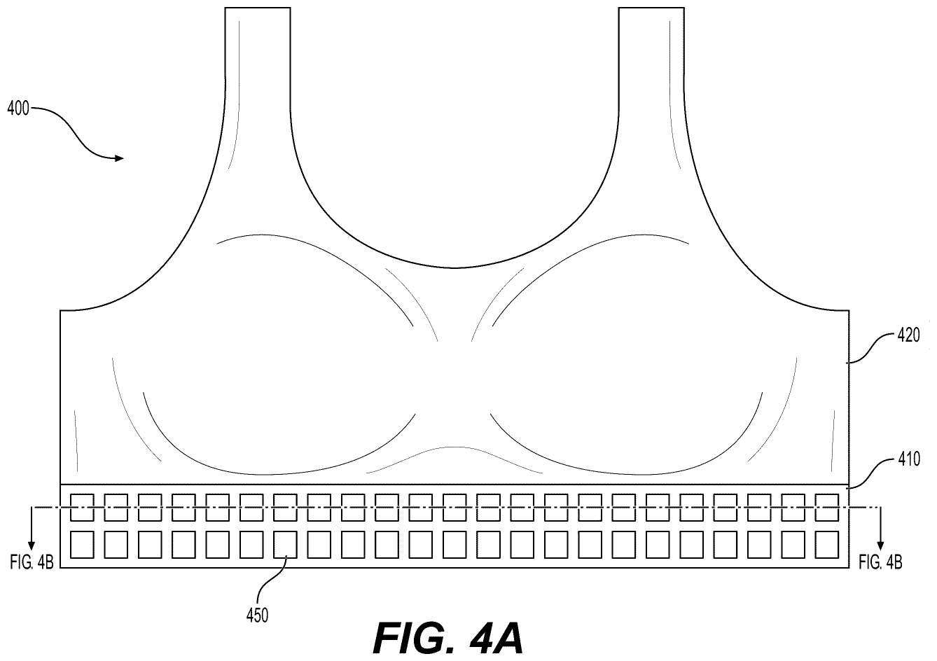

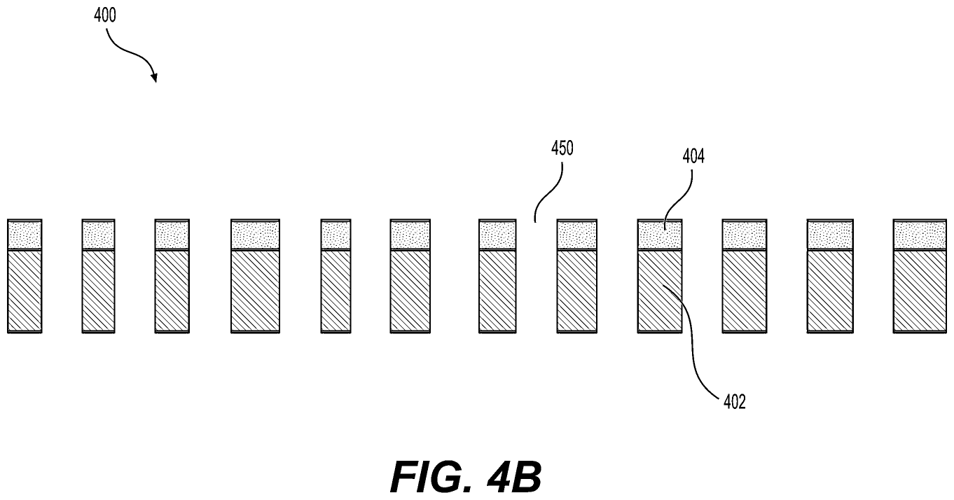

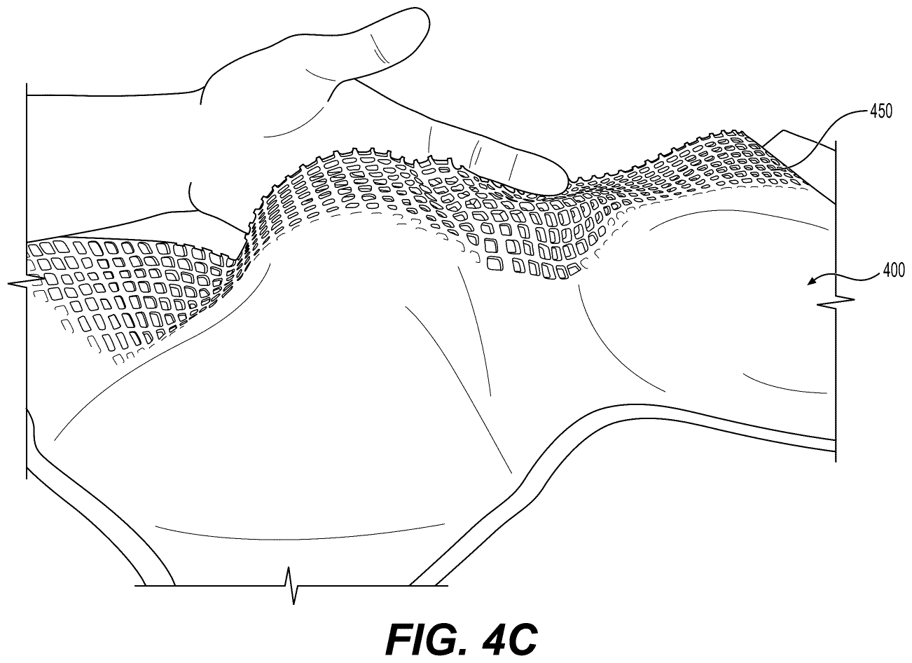

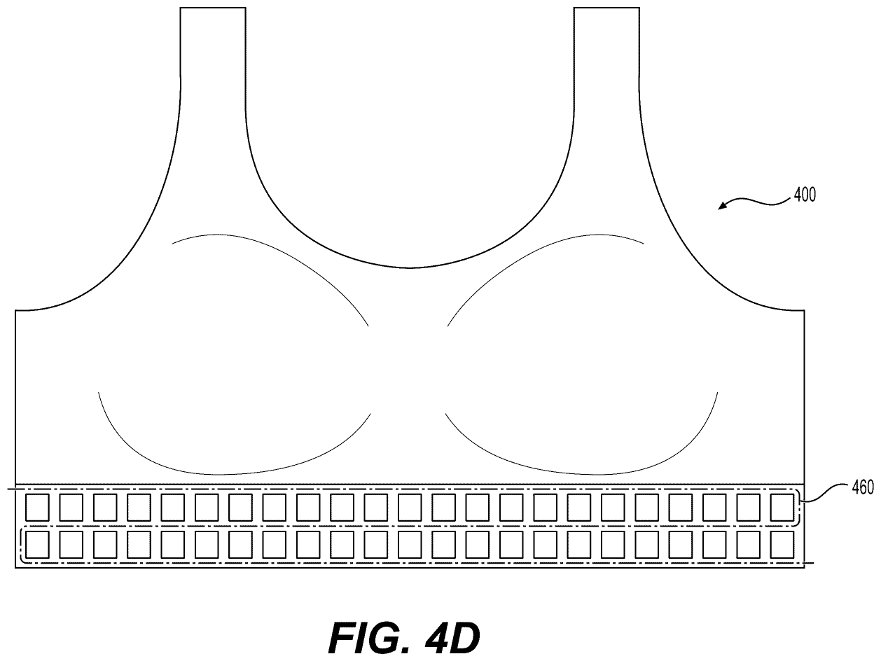

FIG. 3 illustrates an exemplary mold 310 configured to be used with the liquid spray deposition system 100, and FIGS. 4A-4D illustrates an exemplary article of apparel 410 created by applying the liquid material 130 and/or the plurality of fibers 150 (FIG. 1) to the exemplary mold 310. Referring to FIGS. 3 and 4A, the mold 310 may be in a shape of one side (e.g., front or rear) of a garment or article of apparel 400 (e.g., a sports bra). Although a sports bra is shown in FIG. 3 as an example, aspects disclosed herein are not limited to a type of garment created. Formed at least in part by spray deposition of one or more materials onto a mold 310, article of apparel 400 may be considered a molded article.

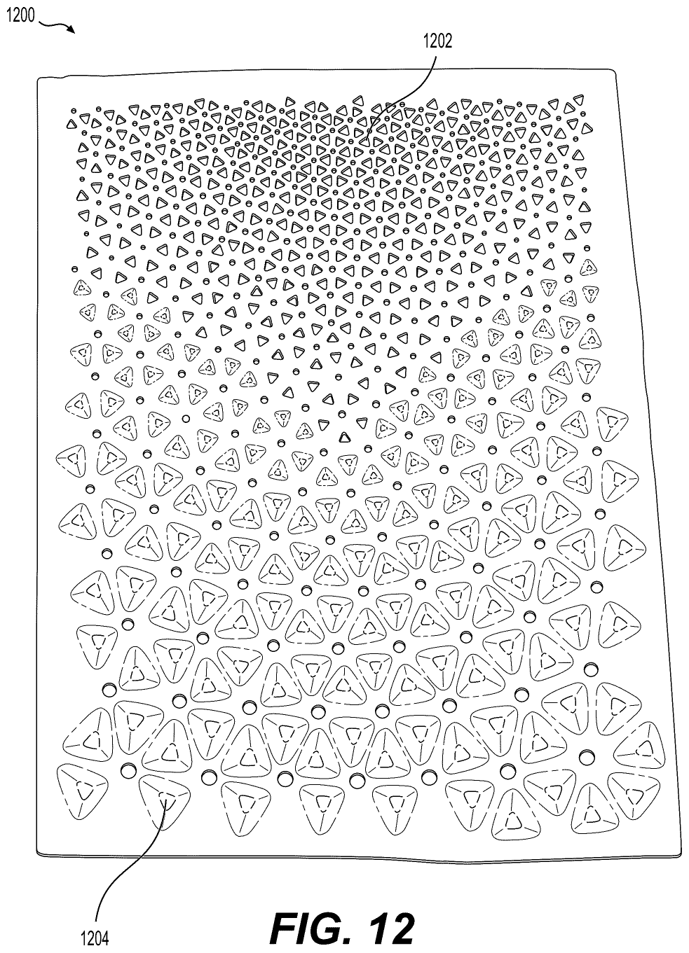

The mold 310 may include a plurality of openings or holes 350 configured to produce a corresponding plurality of openings or holes 450 in a resulting article of apparel 400. An orientation, size, shape, position, density, etc. of the plurality of openings 350 may be configured to result in the plurality of openings 450 in the article of apparel 400 to provide ventilation, support, flexibility, elasticity, and/or insulation to the article of apparel 400. In some examples, the mold 310 may include a plurality of protrusions arranged between and/or in various areas between the plurality of openings 350 to result in corresponding protrusions and/or openings in the article of apparel 400 (e.g., as illustrated in FIG. 12). For example, some protrusions may help with breathability by creating a concave recess, with respect to a user, and reducing an amount of material touching a user's skin. The plurality of openings 350 in the mold 310 and/or the plurality of openings 450 in the article of apparel 400 may include ten or more openings, twenty or more openings, thirty or more openings, forty or more openings, fifty or more openings, or any other suitable number of openings. In some embodiments, the mold 310 and/or the article of apparel 400 may include a first plurality of openings and a second plurality of openings that differ in size from the first plurality of openings. For example, a single layer of an article of apparel 400 may include a first plurality of openings (e.g., macro-openings) and a second plurality of openings (e.g., micro-openings) that are smaller in size (e.g., diameter) than the first plurality of openings. The second plurality of openings may be configured to provide more and/or additional drape and/or breathability to the article of apparel 400.

The mold 310 may include a first section 320 and a second section 330. The first section 320 may include the plurality of openings 350, and the second section 330 may be different from the first section 320 in an arrangement or presence of openings, a texture, and/or a contour. For example, the mold 310 shown in FIG. 3 may be used for a sports bra, the first section 320 may correspond to a band section or portion 410, and the second section 330 may include a section having two round or semi-spherical protrusions to provide support.

The plurality of openings 350 of the mold 310 and/or the plurality of openings 450 in the article of apparel 400 may be macro-openings and/or have a size and shape such that, when the liquid material 130 and/or the plurality of fibers 150 (FIG. 1) are deposited toward the mold 310, the liquid material 130 and/or the plurality of fibers 150 do not fill the plurality of openings 350 of the mold 310. For example, a size of the plurality of openings may be larger than a droplet size of the liquid material 130. As used herein, the term “macro-opening” refers to an opening or aperture of any shape in an article of apparel comprising a polymer material. The macro-openings may, in some embodiments, include openings obtained using one or more overhangs on the molds described herein. In at least one embodiment, the macro-opening(s) are visible to a viewer from a distance of at least 1 meter (m), or at least 2 m, or at least 3 m, or at least 4 m, or at least 5 m. In some embodiments, the macro-openings may include a dimension, e.g., a diameter, of at least 0.5 mm. In some embodiments, the macro-openings may include a dimension between 0.5 mm and 5 mm.

Referring to FIGS. 3 and 4B, the liquid material 130 (FIG. 1) may form a first material 402 when dried and/or cured, and the plurality of fibers 150 (FIG. 1) may form a second material 404. Due to the design of the plurality of openings 350, pooling of the liquid material 130 may be reduced or eliminated such that the plurality of openings 450 in the article of apparel 400 extend through the entire article of apparel, including both the first material 402 and the second material 404. In addition, a size, arrangement, shape, etc. of the plurality of openings 350 may be configured to result in certain predetermined properties, such as ventilation and/or flexibility. The plurality of openings 350 in the mold 310 may facilitate ventilation in predetermined areas of the article of apparel 400 where ventilation might otherwise may be difficult to achieve using previous techniques such as cutting fabric. For example, if article of apparel 400 is a sports bra, the plurality of openings 350 in the mold 310 may be louvered so as to keep sweat from pooling in the band section of sports bra. Referring to FIG. 4C, the resulting article of apparel 400 may be flexible when handled and/or donned.

Referring to FIG. 4D, the article of apparel 400 may include a reinforcement element, such as a cable or thread 460 provided in a predetermined area of the article of apparel 400, such as a reinforcement portion. The cable 460 may include a brio cable and/or a plastic cable and may be coupled to (e.g., woven or threaded in) areas between the plurality of holes 450, but aspects disclosed herein are not limited to where the cable 460 may be provided and/or an arrangement of the cable 460. For example, the cable 460 may extend between rows and/or columns of the plurality of holes 450.

In some examples, the cable 460 may have the configurations of filament yarn (e.g., monofilament yarn, multifilament yarn), spun yarn, thread, rope, webbing, cable, or chain, for example. Although the cross-sectional shape of cable 460 may be round, any shape (e.g., triangular, square, rectangular, elliptical, or irregular shape) may also be utilized.

Moreover, the materials forming the cable 460 may include a thermoplastic polymer or a thermoset polymer. As used herein, the term “thermoplastic polymer” refers to a polymeric material or a polymer that is a solid when cooled and is capable of being repeatedly softened and melted upon heating. As used herein, the term “thermoset polymer” refers to a polymeric material or a polymer that is initially flowable but is a solid at room temperature and is not capable of being repeatedly melted upon heating, as on heating, the polymeric material or polymer decomposes before melting. As used herein, the term “thermosetting” refers to a process whereby a polymeric material or a polymer that initially is flowable is solidified, such that the polymeric material or polymer cannot be repeatedly melted upon heating, as on further heating, the polymeric material or polymer decomposes before melting. In some examples, the polymeric material may be an elastomeric material, in which the one or more polymers of the elastomeric material comprises, consists essentially of, or consists of one or more elastomers. As used herein, the term “elastomer” refers to a polymer having an elongation at break of greater than 100 percent, such as of greater than 200 percent, or of greater than 400 percent, as determined using ASTM D-412-98 at 25 degrees Celsius. Example materials forming the cable may include but not limited to cotton, elastane, polyester, rayon, wool, and nylon. Further, cable 460 may have greater stretch-resistance than the article of apparel.

The cable 460 may be configured to provide additional support, stability, and/or structure to predetermined areas of the article of apparel 410. As exemplified in FIG. 4D, the cable 460 may be coupled to the article of apparel 410 in an S or sinusoidal shape to provide reinforcement to the article of apparel 400 to the predetermined area. In some examples, the cable 460 may be arranged to create multiple lines, rows or columns of the cable 460 to provide reinforcement. In yet other examples, the cable 460 may have a serpentine, wavy, or crinkle crankle wall shape configured to provide reinforcement. For example, when used in an upper for a footwear, cable 460 may help secure the upper, reduce deformation in the area of the upper (e.g., imparts stretch resistance), and may be configured to form loops as part of a lacing system for the footwear through which a lace cable may be threaded. Aspects disclosed herein are not limited to a stitching and/or embroidery pattern of the cable 460. In some examples, the cable 460 may be elastic and may be configured to provide elasticity.

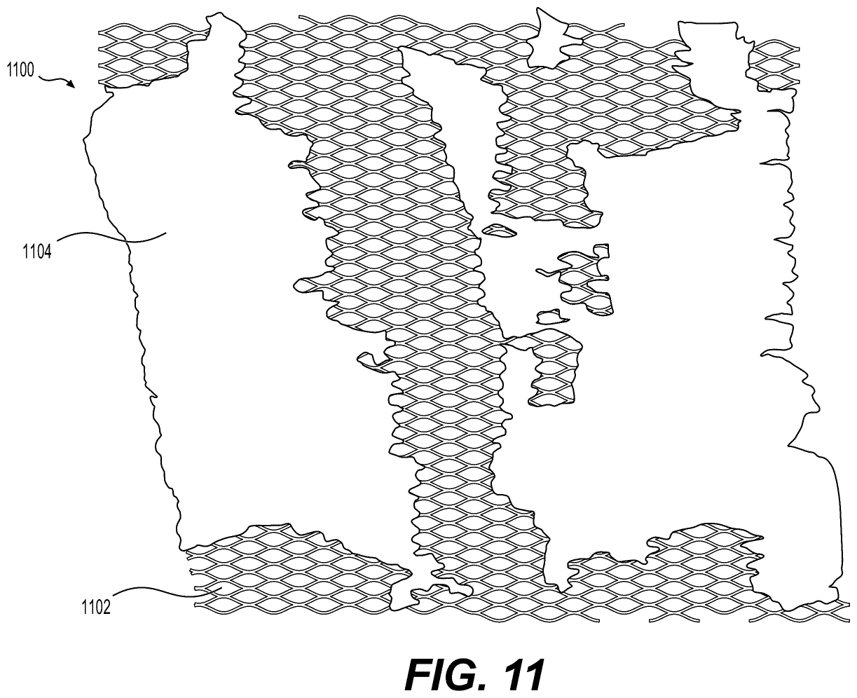

As an alternative to cable 460, the reinforcement element may include a second layer of material (e.g., liquid material 130 and/or the plurality of fibers 140) to form a scrim. The second layer of material may include a second material different from the liquid material 130, the plurality of fibers 140, and/or differ in a texture or arrangement (e.g., lack of holes), elasticity, etc. (e.g., as shown in FIG. 11).

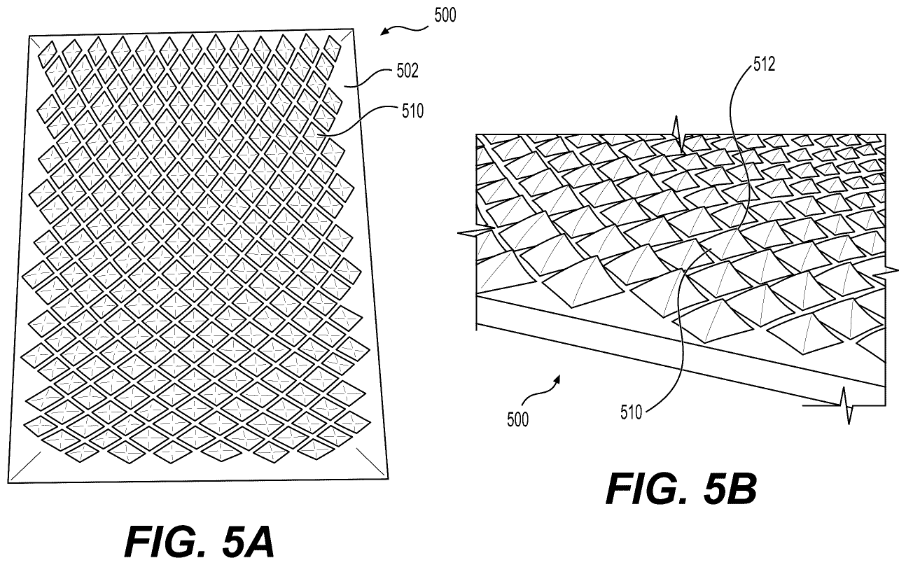

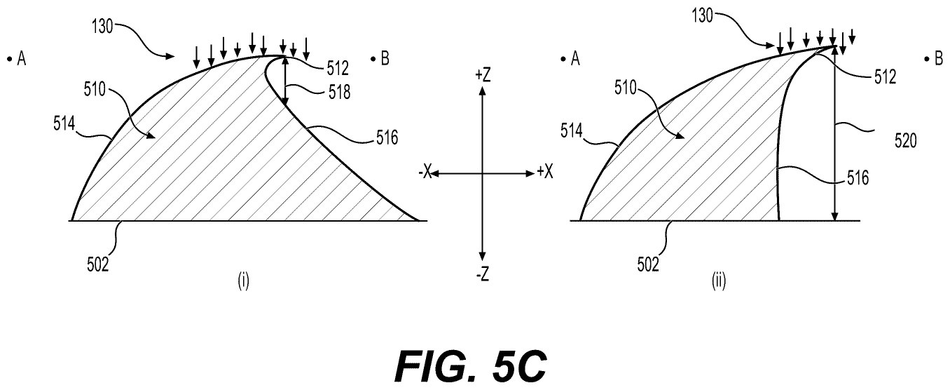

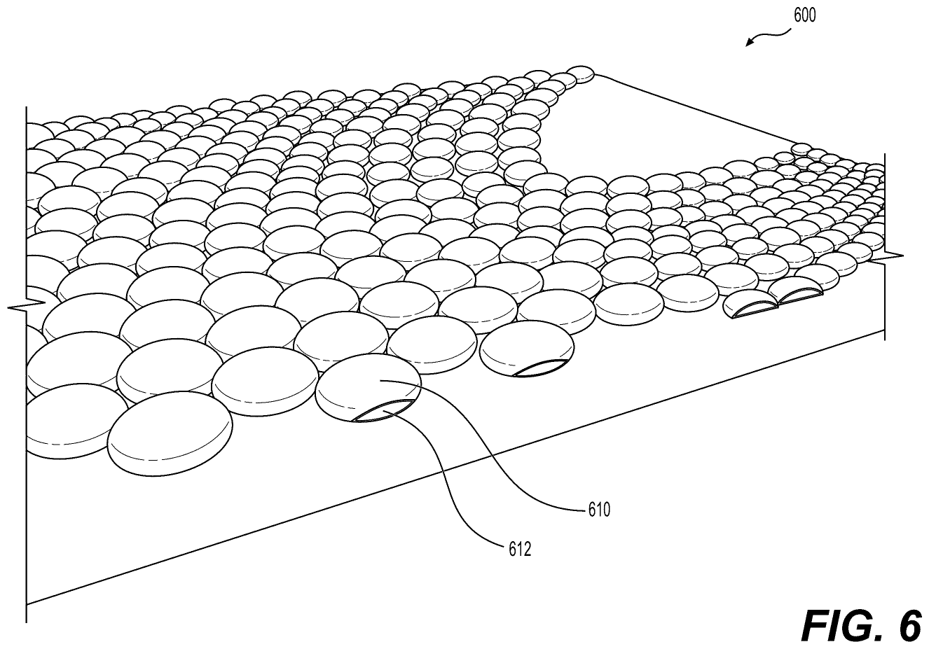

FIGS. 5A-5C illustrate a mold 500 configured to be used with the liquid spray deposition system 100 and configured to produce openings in a resulting article of apparel 600 (FIG. 6). Referring to FIGS. 5A-5B, and 6, the mold 500 may include a base surface 502 and a plurality of protrusions 510. Each of the plurality of protrusions 510 may include an end or tip 512. The resulting article of apparel 600 may include a plurality of protrusions or protuberances 610 corresponding to the plurality of protrusions 510. Accordingly, the plurality of protrusions or protuberances 610 may be integrally formed with the with article of apparel 600. Each tip 512 may create an overhang or extension over the base surface 502 that is configured to result in an opening or slit 612 formed between adjacent protrusions 610 in the article of apparel 600 when a liquid polymer is sprayed toward the tip 512.

FIG. 5C shows examples of a cross-sectional design of each protrusion 510 to produce the slit 612. Referring to FIG. 5C, each protrusion 510 may protrude with respect to the base surface 502. The protrusion 510 may have a shark tooth shape, but aspects disclosed herein are not limited to a specific shape of the protrusion 510 so long as the tip 512 forms an overhang. The base surface 502 may extend in an X-direction, and the protrusion 510 may extend in a Z-direction and the X-direction. The protrusion 510 may include a first side 514 and a second side 516 opposite the first side 514 in the X-direction. The first side 514 may be curved and/or rounded, and gradually extend to the tip 512. The second side 516 may extend from the tip 512 down to the base surface 502 and may similarly have a smooth curvature. However, aspects disclosed herein are not limited to curvatures of the first side 514 and the second side 516 so long as the tip 512 creates an overhang with respect to the second side 516 and/or the base surface 502. For example, the first side 514 and/or the second side 516 may have portions that may have a straighter or linear cross-section and/or that appear as a ramp.

As shown in FIG. 5C, view (i), the first side 514 may have a convex curvature with respect to a reference point A outside of the protrusion 510, and the second side 516 may have a concave curvature with respect to a reference point B the outside of the protrusion 510. The second side 516 may extend beyond the tip 512 in the X-direction to form a gap 518, in the Z-direction, between an end of the tip 512 and the second side 516. The gap 518 may be a fraction of a total height of the protrusion 510. When liquid material 130 is deposited toward the protrusion 510, the liquid material 130 deposited on the first side 514 may be separate from the liquid material 130 deposited on the second side 516, resulting in the opening 612 formed in the article of apparel 600. The opening 612 may be a macro-opening.

As shown in FIG. 5C, view (ii), a similar effect may occur when the tip 512 extends beyond the second side 516 in the X-direction to form a gap 520, in the Z-direction, between an end of the tip 512 and the base surface 502. The gap 520 may be equal to a total height of the protrusion 510. When liquid material 130 is deposited toward the protrusion 510, the liquid material 130 deposited on the first side 514 may be separate from the liquid material 130 deposited toward the base surface 502, resulting in the opening 612 formed in the article of apparel 600. That is, when liquid material 130 is deposited towards the protrusion 510, the protrusion 510, particularly tip 512, is configured to block (i.e., overhang) at least a portion of the base surface 502 of the mold 500 so as to cause the liquid material 130 to not be deposited on the at least a portion of the base surface 502, thereby resulting in the opening 612 formed in the article of apparel 600. In the example of FIGS. 5A-5C, the mold 500 does not include any openings or holes yet is configured to form the openings 612 in the article of apparel 600. The dimensions, shape, size, arrangement, curvature, gaps, etc. of the protrusions 510 may be configured based on a composition of the liquid material 130 and/or based on desired properties, such as breathability, ventilation, flexibility, etc. The plurality of protrusions 510 in the mold 500 may facilitate ventilation in predetermined areas of the article of apparel 600 where ventilation might otherwise may be difficult to achieve using prior techniques and/or simply cutting a final swatch or fabric. In addition, a curvature and/or shape of the first surface 514, the second surface 516 and/or the tip 512 may be configured to produce a predetermined shape or curvature of the protuberance 610 of the article of apparel 600. For example, the first surface 512 may have a round shape to produce a round protuberance 610 having a convex curvature that extends away from a surface or a body of the article of apparel 600. A thickness of protuberance 610 may vary (e.g., increase or decrease) in the direction that the curvature of the protuberance 610 extends away from the surface or the body of the article of apparel 600. The protuberance 610 may also include a peripheral edge, and the opening 612 may be included in the peripheral edge of the protuberance 610. In other examples where the article of apparel 600 includes at least one protuberance 610 and at least one opening 612, the plurality of protrusions 510 in the mold 500 may facilitate breathability, and ventilation in predetermined areas of the article of apparel 600. For example, if the article of apparel 600 is a jacket, the curvature of the protuberance 610 can facilitate draining of water while the opening 612 provides breathability and ventilation.

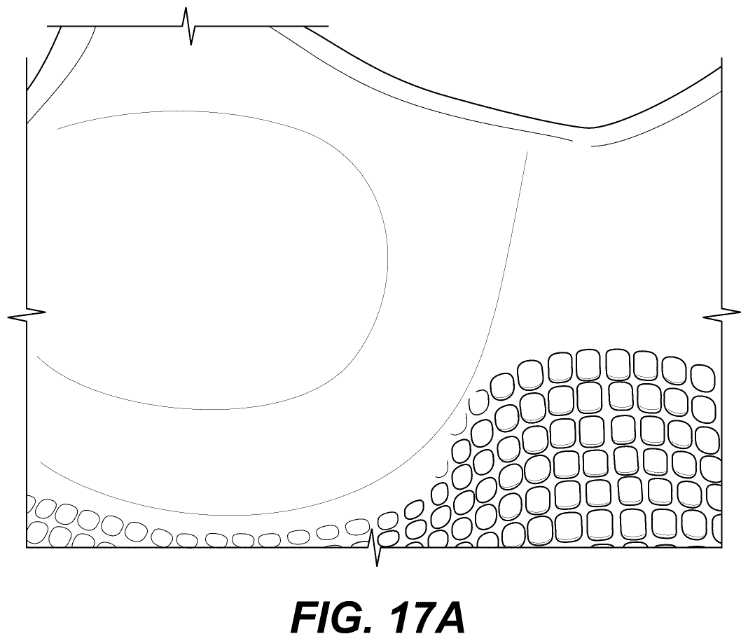

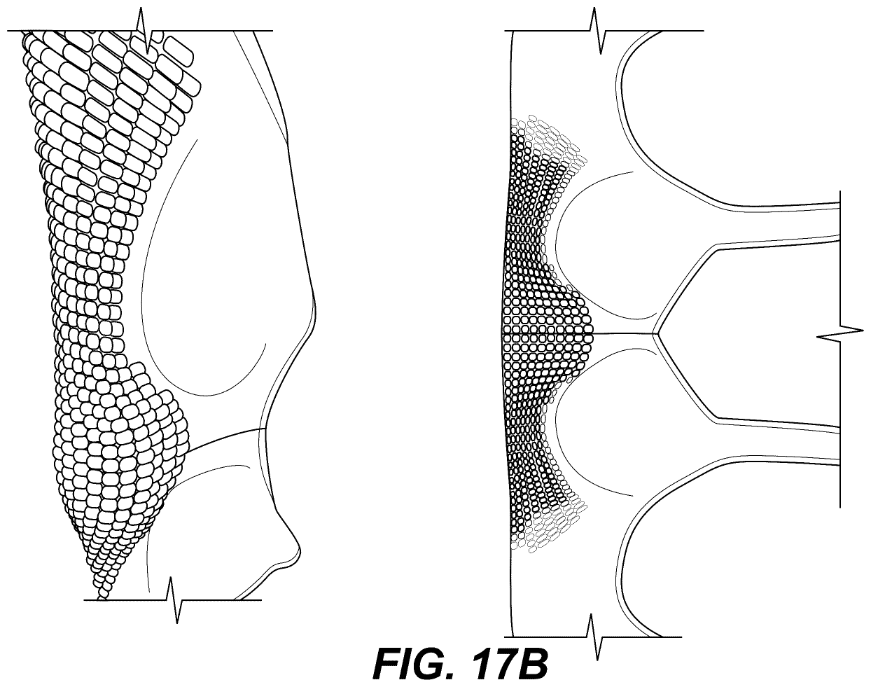

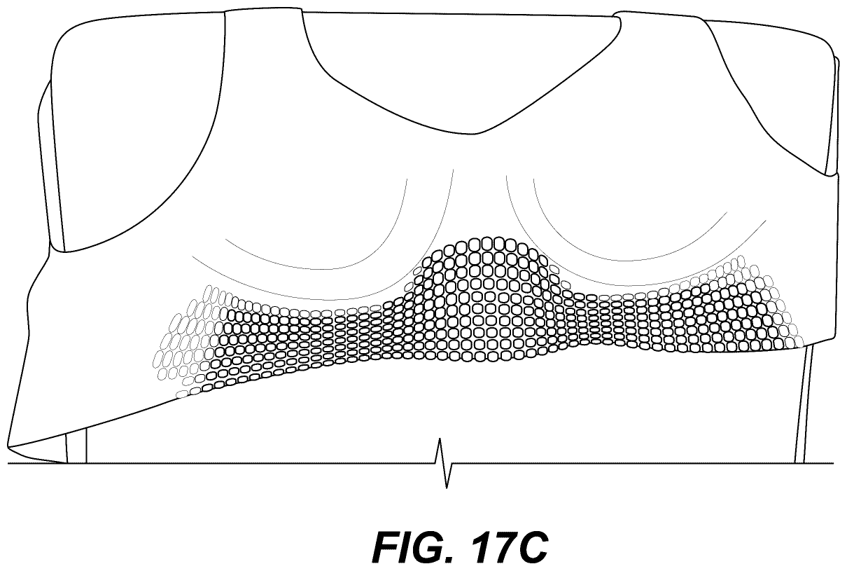

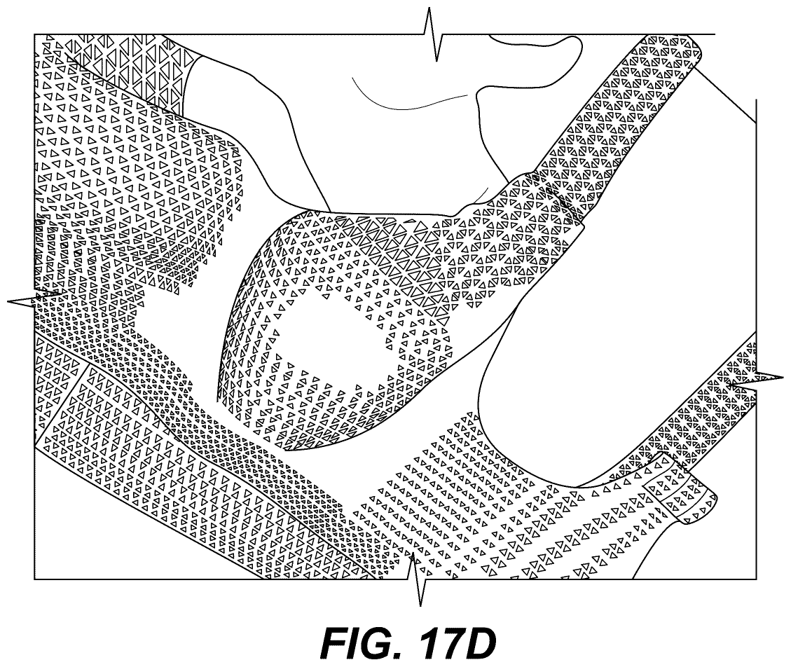

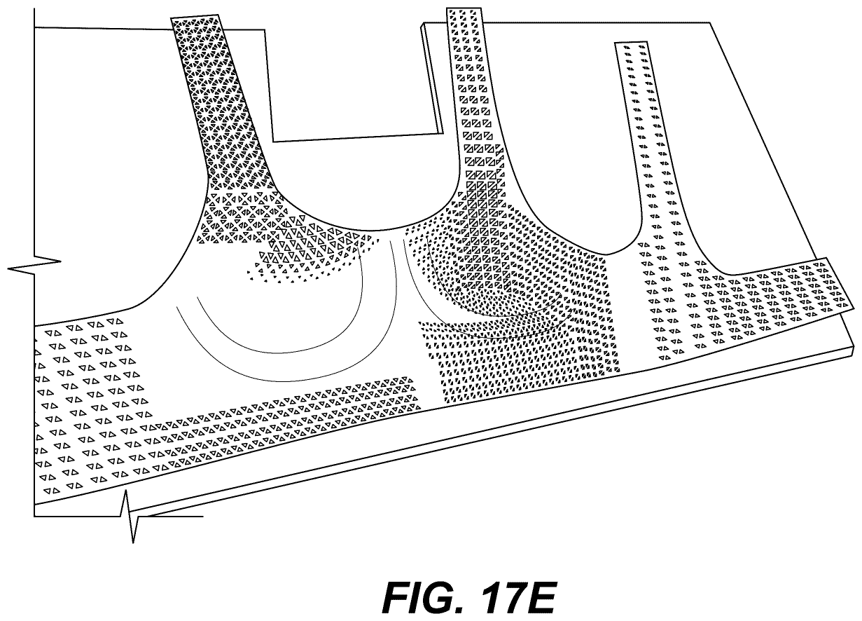

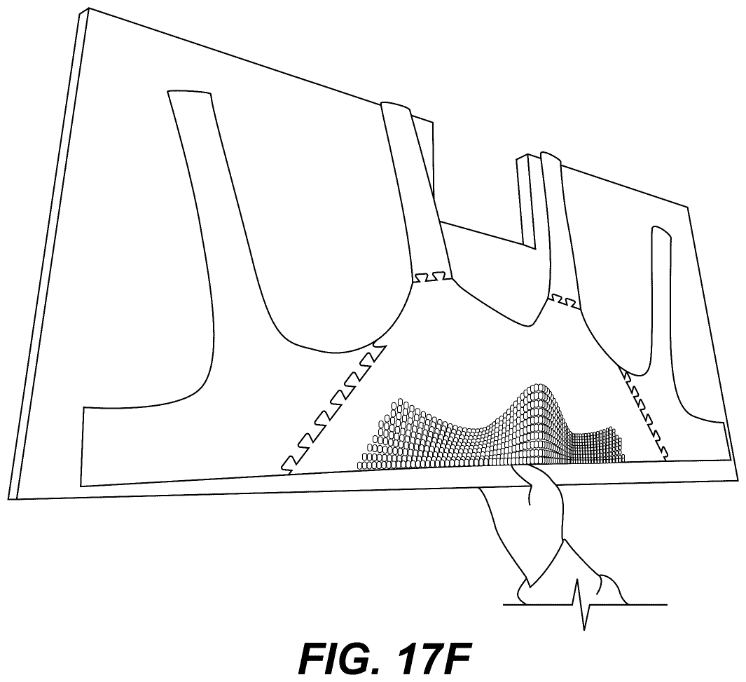

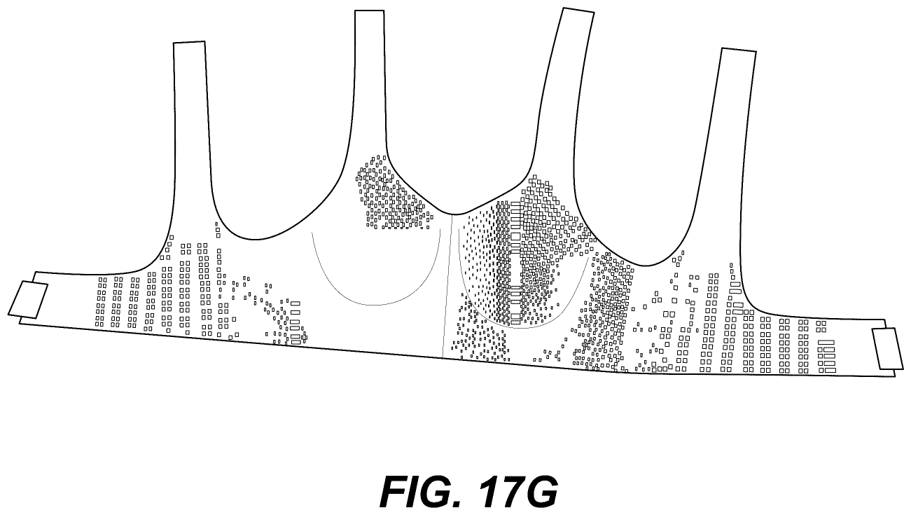

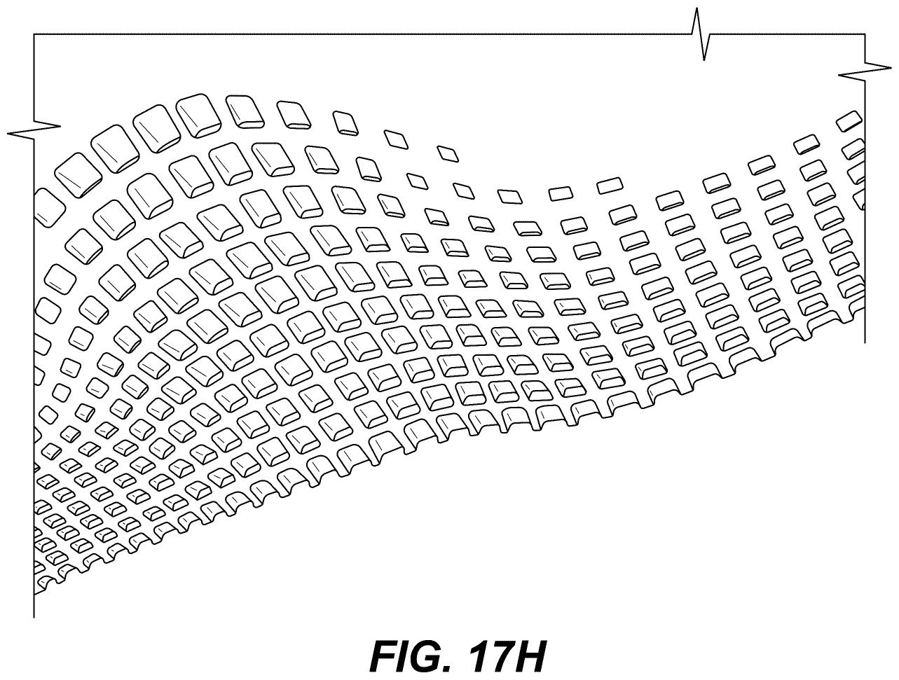

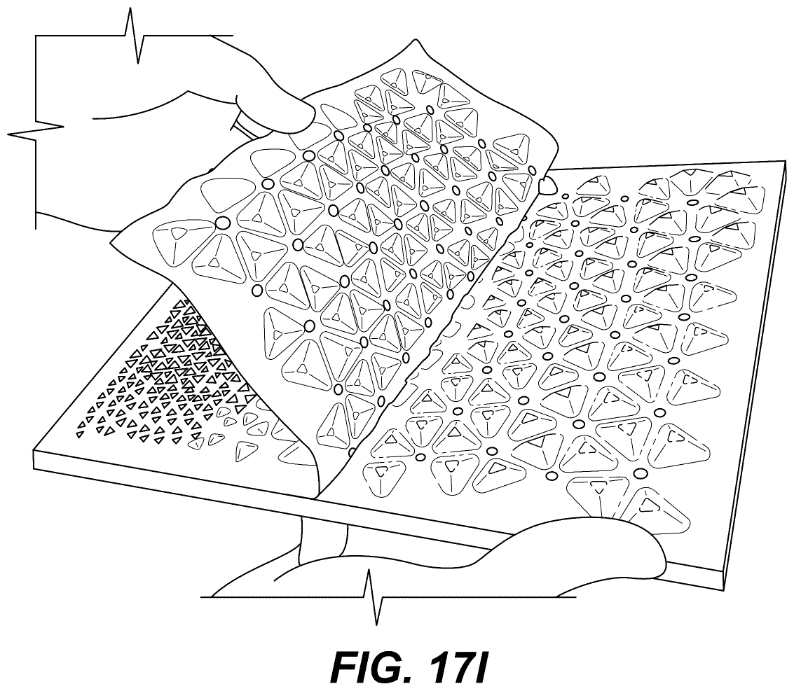

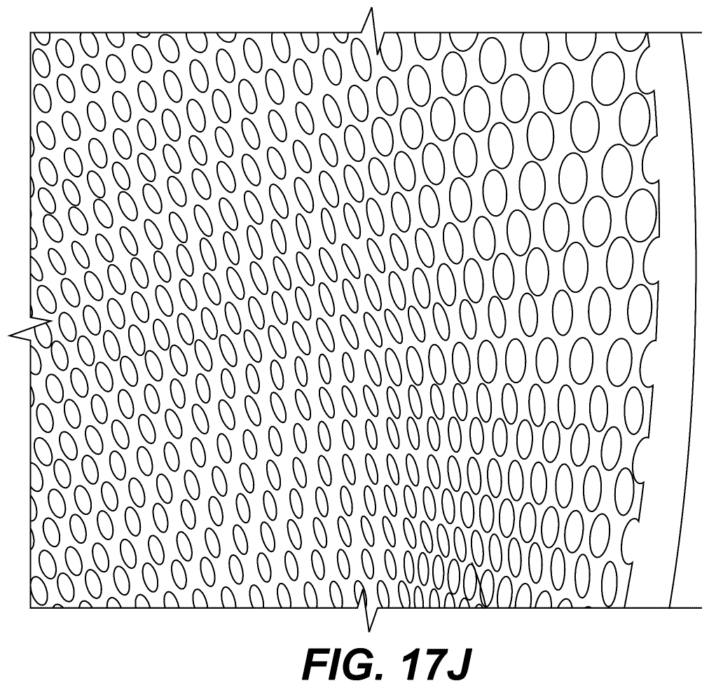

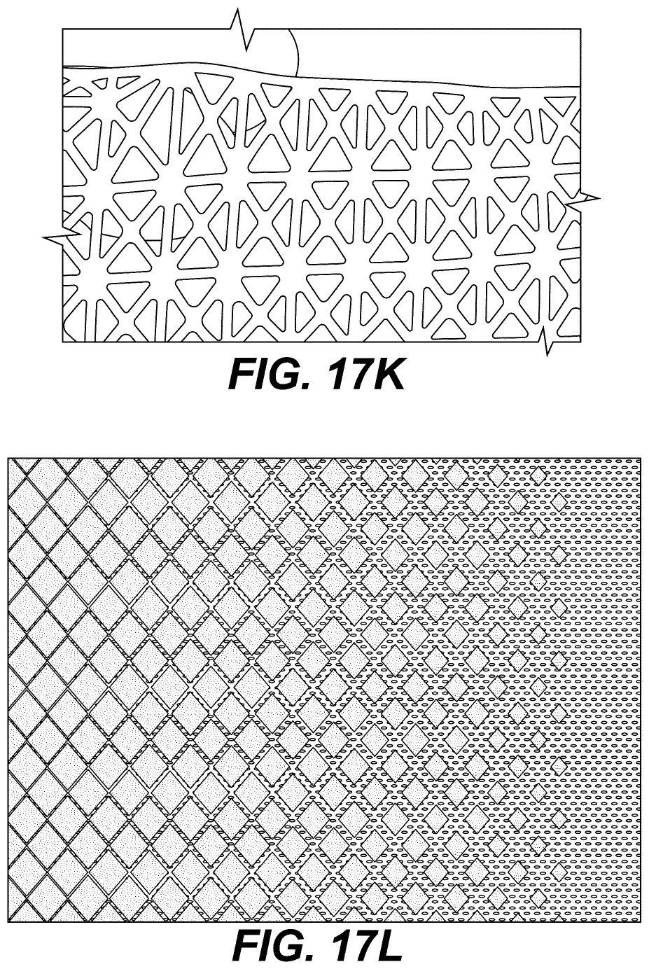

In some examples, the mold 500 may include a plurality of protrusions 510, in which each protrusion 510 extends in a z-direction with respect to a top surface of the mold 500 and includes at least one side face having a negative draft angle. As used herein, the term “draft angle” is defined in terms of the mold surface and the direction of pull required to remove an article of apparel from a mold, and refers to the taper (i.e., draft) added to the mold surface. Thus, a “negative draft angle” refers to the gradual decrease in the angle of the mold surface relative to the direction of pull required to remove the article of apparel from the mold (i.e., the taper slopes inward), and a “positive draft angle” refers to the gradual increase in the angle of the mold surface relative to the direction of pull required to remove the article of apparel from the mold (i.e., the taper slopes outward). As discussed above, the gaps and shapes of the protrusions 510 may be configured based on the composition of the liquid material 130 and/or based on desired properties, such as breathability, ventilation, flexibility, etc. For example, in the cases where the mold 500 includes a plurality of protrusions 510 that each include a side face having a negative draft angle, the side face may be curved, angled, etc., and the side face opposite to the side face having a negative draft angle may also be curved, angled, etc. The protrusions 510 described with reference to FIGS. 5A-5C may be used in combination with various types of molds, such as in a predetermined area (e.g., the first section 320 or the second section 330) of the sports bra mold 310 described with reference to FIG. 3 and/or in connection with other molds described herein. For example, as is partially shown in FIG. 17H, the band section of the sports bra mold may include a plurality of depressed cavities and/or protrusions having negative draft angles. In some examples, each depressed cavity and/or protrusion may be further configured to pool (i.e., collect) at least a portion of the liquid material (when deposited) in an amount sufficient to provide additional reinforcement to the resulting article of apparel, particularly to the band section.

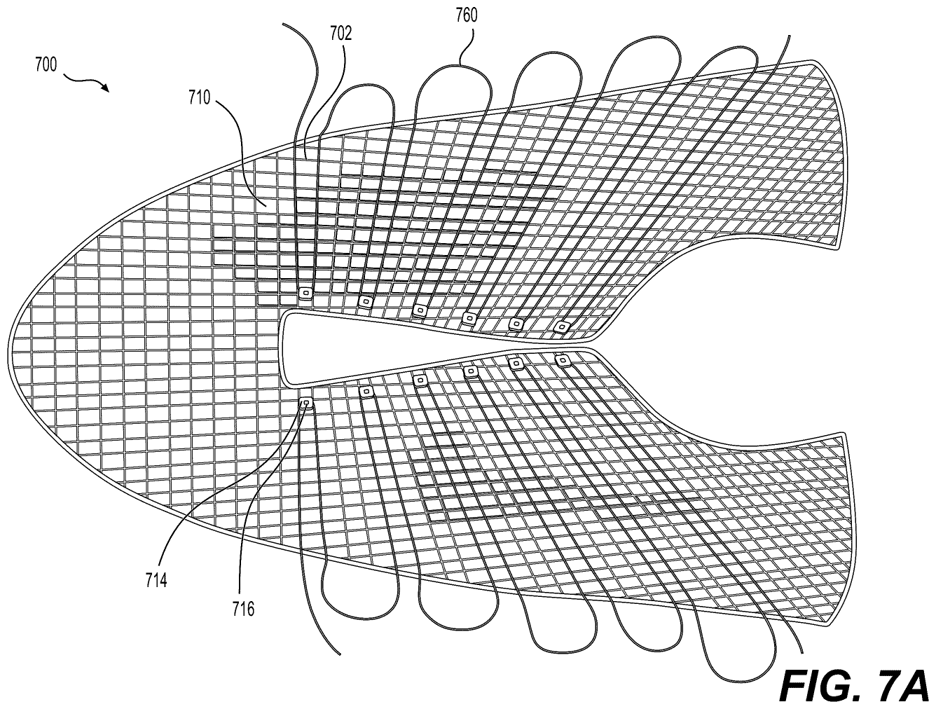

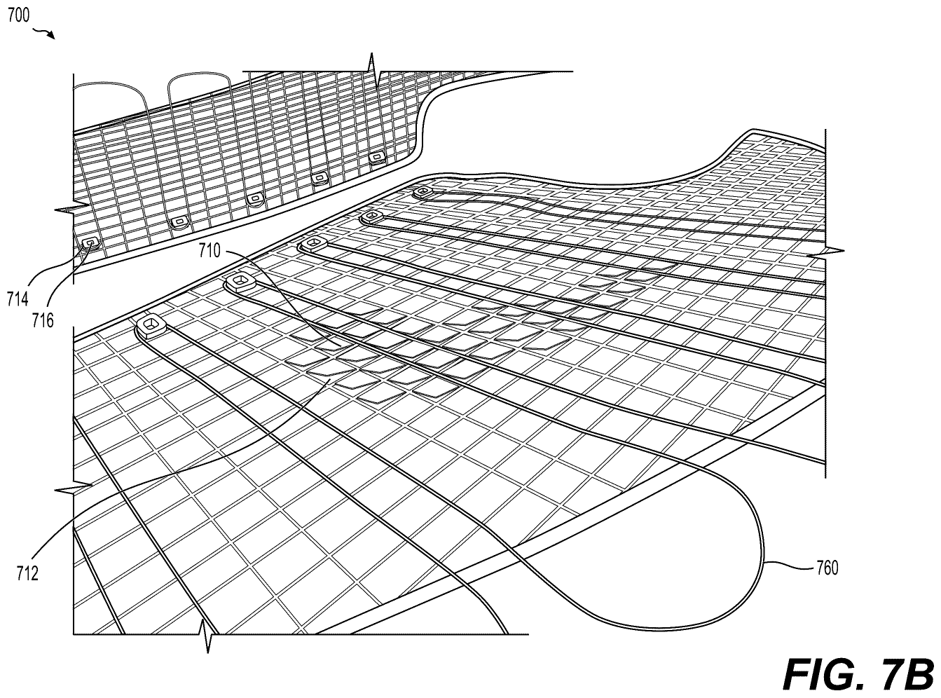

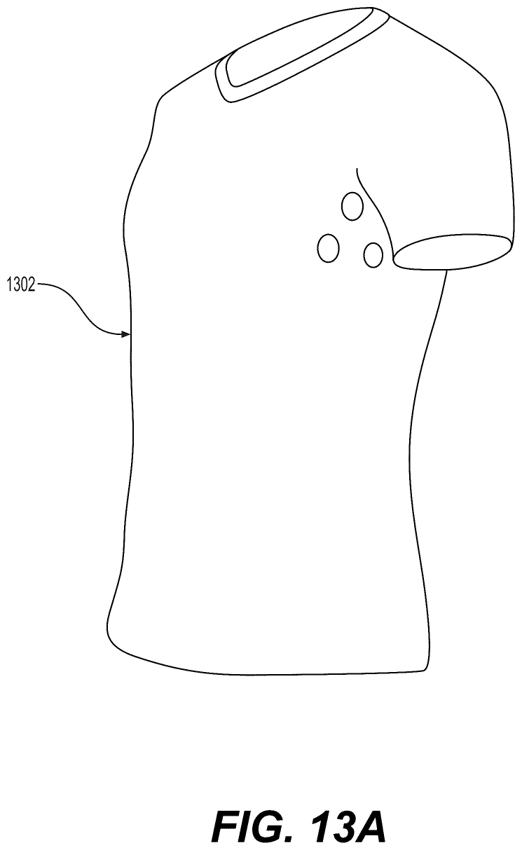

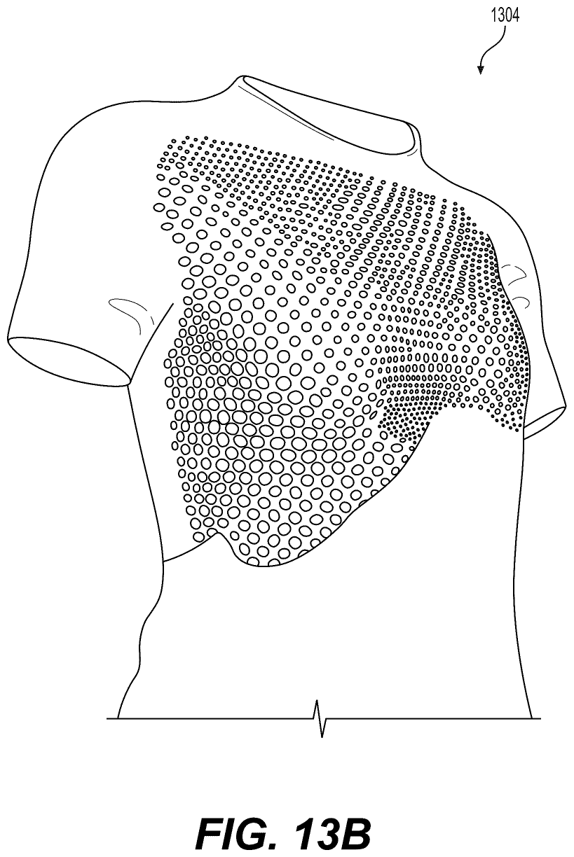

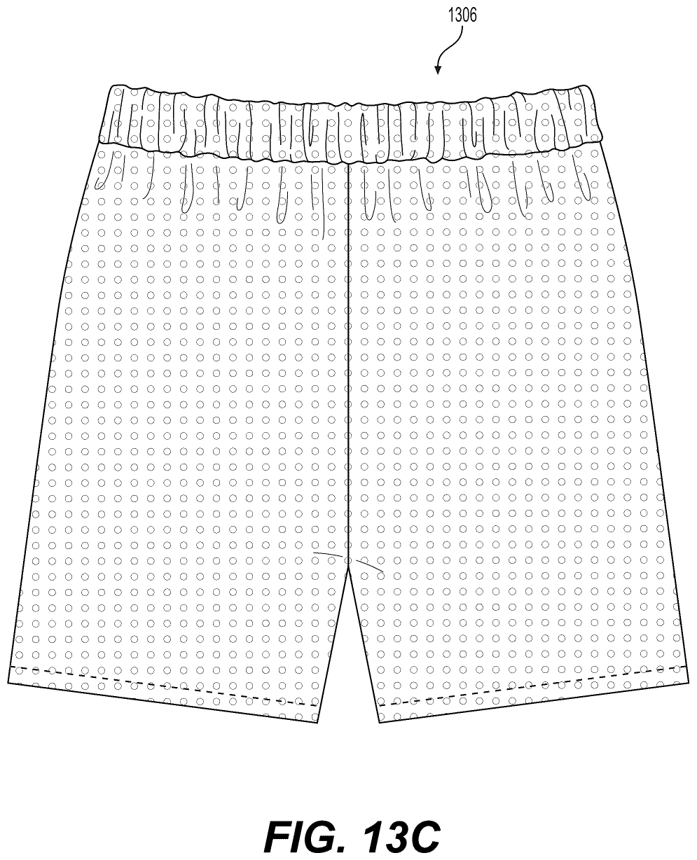

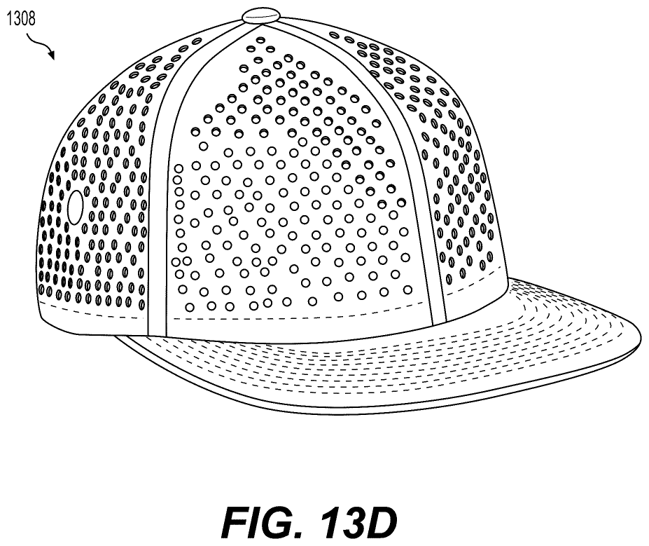

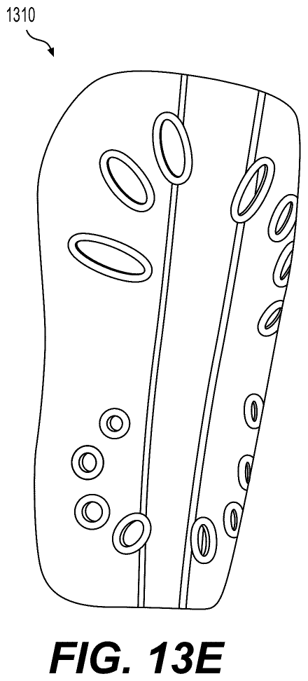

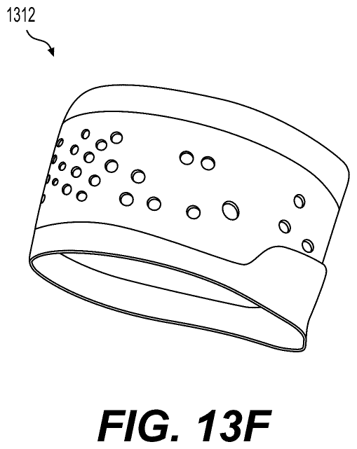

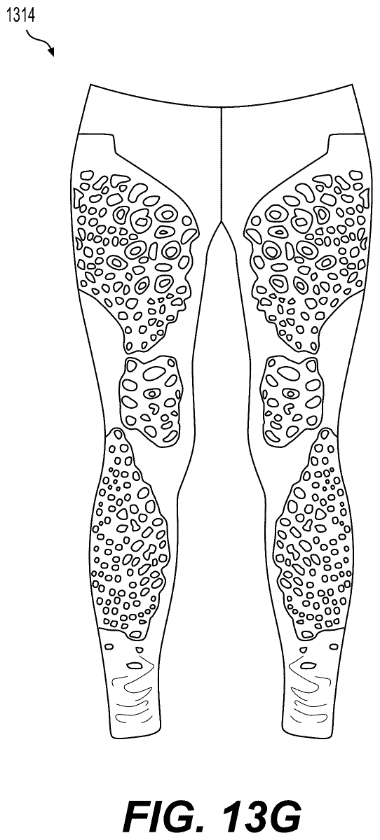

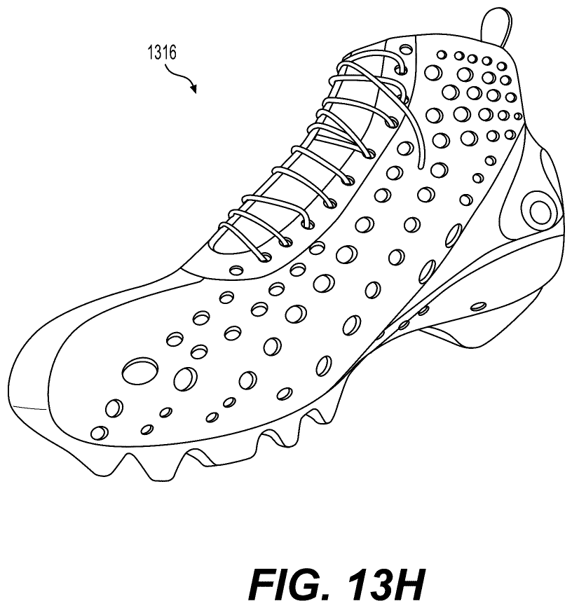

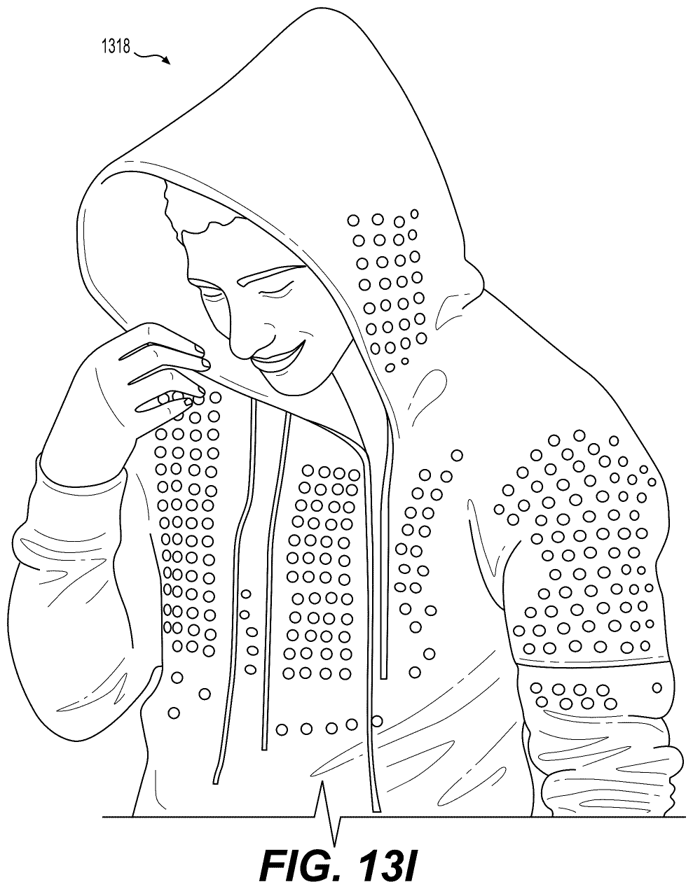

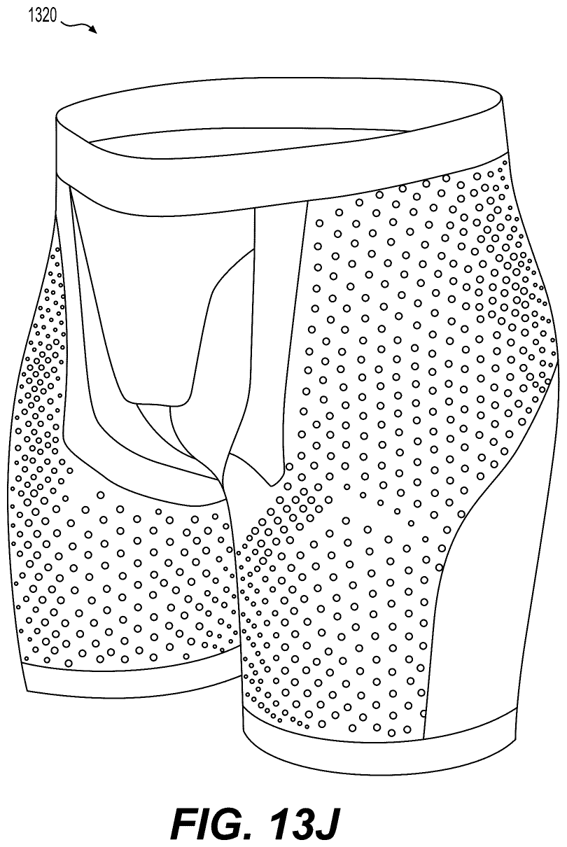

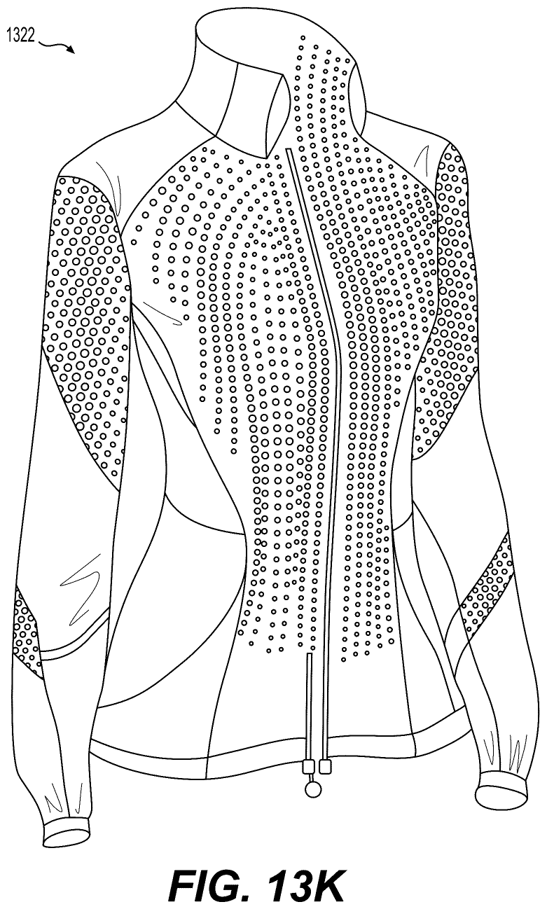

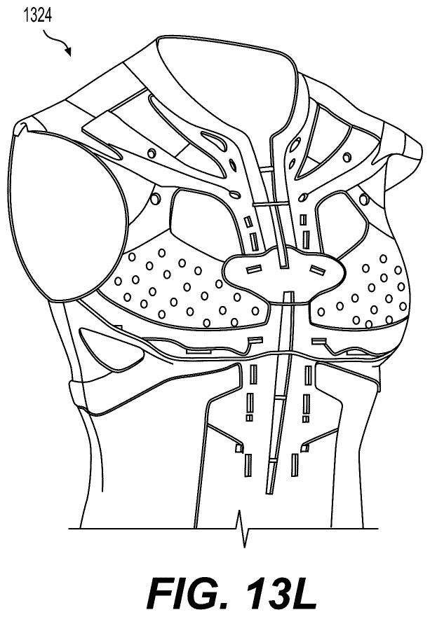

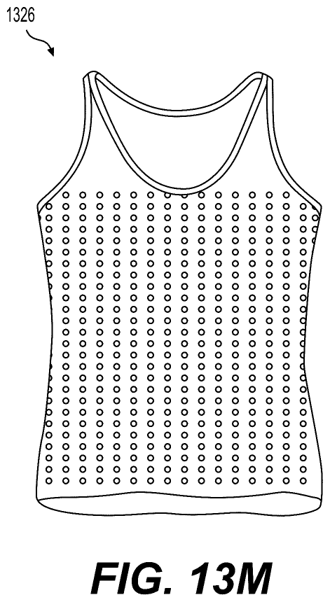

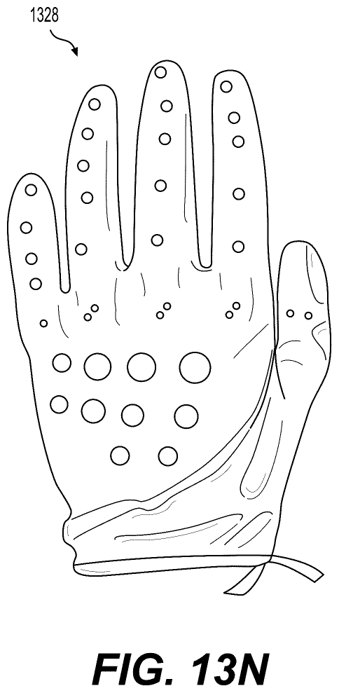

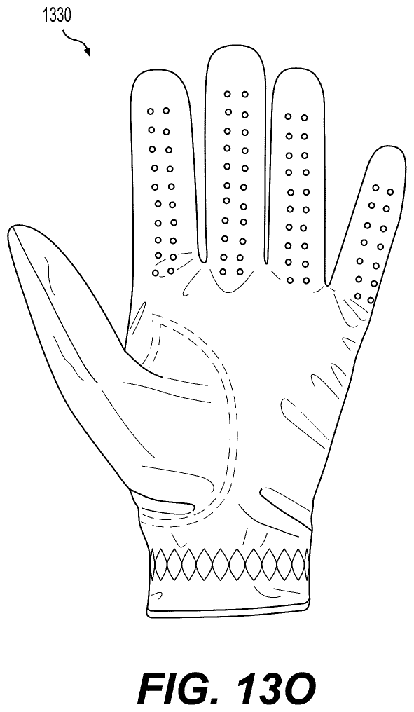

The protrusions 510 may be arranged throughout an entirety of the mold 500 and/or in areas designed for ventilation or breathability in the resulting garment or article of apparel, as exemplified in FIGS. 13A-13O. That is, the orientation, size, shape, position, amount, etc. of the protrusions 510 may be configured to result in the plurality of the protuberances 610 and/or openings 612 in the article of apparel 600 to provide ventilation, support, flexibility, elasticity, and/or insulation to the article of apparel 600 or may be configured to result in the designs illustrated on the garments and articles of apparel shown in FIGS. 13A-13O. For example, as shown in FIG. 5, the protrusions 510 may be arranged in a lattice pattern, but other suitable pattern (e.g., herringbone, argyle, etc.) or shape (e.g., circle, rectangle, square) arrangements may be used. FIGS. 7A and 7B illustrate a shoe upper 700 formed using a mold using overhangs, such as a mold similar to the mold 500 described with reference to FIGS. 5A-5C. Referring to FIGS. 7A-7B, the mold may have had a shape or outline corresponding to a shape or outline of the shoe upper 700. The shoe upper 700 may include a plurality of slits or flaps 710 formed by a plurality of protrusions in the mold and a plurality of openings or slits 712 between at least some of the adjacent flaps 710 among the plurality of flaps 710. Each flap 710 may have a rectangular or square shape, and the openings 712 may surround the flap 710 on at least two sides. The shoe upper 700 may also include a reinforcement element or material 760 (e.g., cable) coupled to the shoe upper 700 and extending between adjacent flaps 710 and/or rows of flaps 710 to provide reinforcement. The shoe upper 700 may also include a plurality of openings or holes 714 configured to receive shoe laces. Each hole 714 may be reinforced with a reinforcement material 716 (e.g., ring such as a plastic or polymer ring), and the cable 760 may extend to at least partially surround and/or wind around the reinforcement ring 716 to provide additional reinforcement.

In some examples, optionally, at least one side (e.g., an upper side) of the shoe upper 700 may have a soft or suede-like texture due to the deposited plurality of fibers 150 (FIG. 1). In some examples, the shoe upper 700 may have been flipped over during production to deposit the plurality of fibers 150 on an opposite side (e.g., lower side).

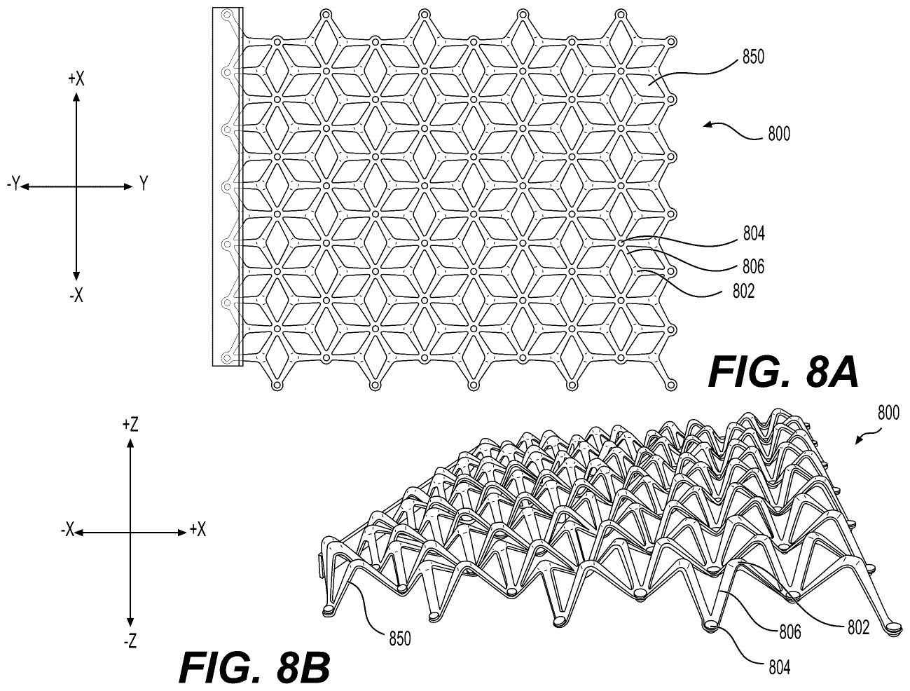

FIGS. 8A and 8B illustrate an example of a three-dimensional lattice-shaped mold 800 configured to be used in connection with the liquid spray deposition system 100 of FIG. 1, with FIG. 8A illustrating a top view and FIG. 8B illustrating a side perspective view. Referring to FIGS. 8A-8B, the lattice-shaped mold 800 may extend in an X-direction and a Y-direction, and have a varying height in a Z-direction. The lattice-shaped mold 800 may have a plurality of openings 850 configured to produce a corresponding plurality of openings in a resulting article of apparel. The varying height in the Z-direction may at least partially define the plurality of openings 850 and be configured for various properties (e.g., insulation).

The mold 800 may have a lattice shape to include a plurality of supports, where each support includes one or more first or top ends or vertices 802 and one or more second of bottom ends or vertices 804 that are below, in the Z-direction, from the plurality of top ends 802. The mold 800 may further include a plurality of extensions 806 connecting the plurality of top ends 802 and the bottom ends 804. As exemplified in FIGS. 8A and 8B, the lattice shape of the mold 800 may be arranged such that each top end 802 connects to three extensions 806 and each bottom end 804 connects to six extensions 806 (or alternatively, such that each top end 802 connects to six extensions 806 and each bottom end 804 connects to three extensions 806) but aspects disclosed herein are not limited to a number of extensions 806 connected to the top ends 802 and/or the bottom ends 804. For example, the lattice shape of the mold 800 may include a cubic structure, a pyramid structure, a hexagonal structure, etc. At a periphery or edge, each top end 802 may be connected to less (e.g., three) extensions 802 and each bottom end 804 may be connected to less (e.g., two) extensions 806. The plurality of supports of the lattice structure may have a varying height to at least partially define the plurality of openings in the resulting article of apparel.

An arrangement of the top ends 802, bottom ends 804, and the extensions 806 may be configured such that a resulting article of apparel has insulating properties. For example, the resulting article of apparel may have a three-dimensional lattice structure and be used as loft or filler material inside of a coat, comforter, etc. A distance between the top ends 802 and the bottom ends 804, and an angle and/or length of the extensions 806, may be configured to produce a predetermined size, volume, and/or shape of the plurality of openings 850.

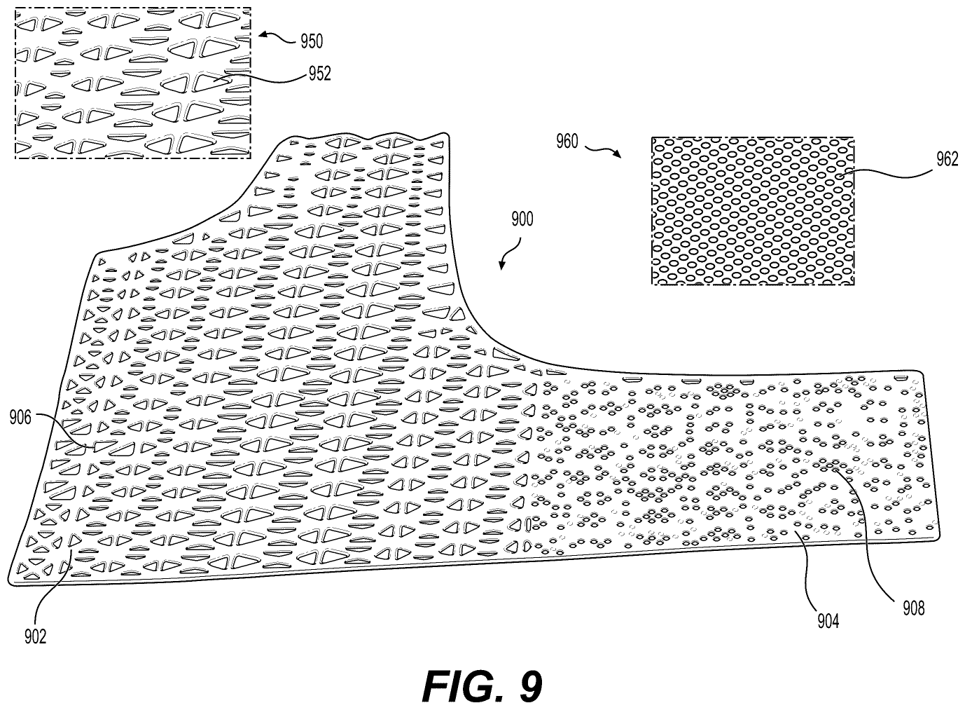

In some examples, two or more molds may be used and/or combined in connection with the liquid deposition spray system 100 to produce differing layers or sections (e.g., for reinforcement) of an article of apparel. In some examples, a single mold may have two or more sections configured to produce different sections in the article of apparel. FIG. 9 illustrates a portion of an article of apparel 900 (e.g., a side or a swatch of a sports bra) created using a first mold 950 and a second mold 960. Referring to FIG. 9, the first mold 950 may have a first plurality of openings 952, and the second mold 960 may have a second plurality of openings 962 that have a different arrangement and/or size of the first plurality of openings 952. The first mold 950 and/or the second mold 960 may have a wire or mesh structure. For example, the first plurality of openings 952 of the first mold 950 may have a predetermined pattern of varying shapes and/or sizes, and the second plurality of openings 962 of the second mold 960 may have a uniform pattern of smaller openings, but aspects disclosed herein are not limited. In a sports bra example, the second plurality of openings 962 may be provided in a section of the second mold 960 corresponding to a rear of a band.

The article of apparel 900 may include a first section 902 and a second section 904. The first section 902 may have been formed using the first mold 950 and include a first plurality of openings 906 corresponding to the first plurality of openings 952 of the first mold 950.

The second section 904 may have been formed using the second mold 960 and/or both the first mold 950 and the second mold 960. The second section 904 may include a plurality of second openings 906 that correspond to the second plurality of openings 962 and/or areas where the second plurality of openings 962 of the second mold 960 overlap with the first plurality of openings 952 of the first mold 950 during a spray deposition process of the liquid material 130 (FIG. 1).

For example, referring to FIGS. 1 and 9, the first mold 950 and the second mold 960 may form a singular and/or integral mold including the first plurality of openings 952 and the second plurality of openings 962, and the liquid material 130 may be sprayed over the singular mold including the first mold 950 and the second mold 960. Alternatively, the first mold 950 may be coupled to and/or laid adjacent to the second mold 960 to form a shape of the article of apparel 900, and the liquid material 130 may be sprayed over the first mold 950 and the second mold 960. As another alternative, the second mold 960 may be smaller than the first mold 950, the second mold 960 may be provided over the first mold 960, and the liquid material 130 may be sprayed over the first mold 950 and the second mold 960. In yet another alternative, a first layer of liquid material 130 may be sprayed over the first mold 950, a second layer of liquid material 130 may be sprayed over the second mold 960, and the second layer of liquid material 130 may be adhered to the first layer of liquid material 130. The second layer of liquid material 130 may provide reinforcement to the first layer of liquid material 130.

In some examples where two molds are used, a second mold may be configured to have openings large enough to define a second layer of liquid material 130, rather than openings. In some examples, multiple deposition and/or curing steps may be used. These multiple deposition and/or curing steps may include multiple molds and/or result in multiple layers, but aspects disclosed herein are not limited.

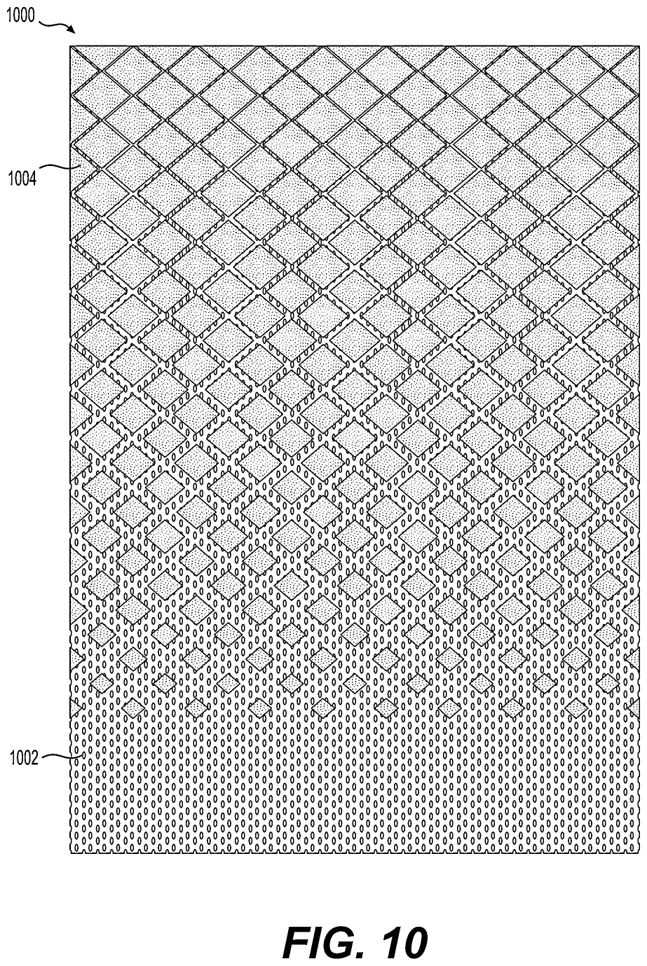

Referring to FIG. 10, an article of apparel 1000 may include a first layer 1002 and a second layer 1004. The first layer 1002 may include a dried or cured liquid material 130 and/or a plurality of fibers 140. The second layer 1004 may include dried or cured liquid material 130 and/or a plurality of fibers 150. The first layer 1002 may include a first plurality of openings and may have been formed using a first mold having a plurality of openings corresponding to the first plurality of openings. The second layer 1004 may be solid, and may have been formed using a second mold or stencil having a second plurality of openings that have a shape large enough to allow the second layer 1004 (e.g., the liquid material 130 and/or the plurality of fibers 150) through to be applied over the first layer 1002. For example, as illustrated in FIG. 10, the second layer 1004 may include a plurality of sections (e.g., diamond shape sections) corresponding to the second plurality of openings of the second mold. The second layer 1004 may be configured to provide reinforcement to the first layer 1002, to change an elasticity, to provide coverage, etc. The second layer 1004 may be a same or different material as the first layer 1002.

In some examples, a second mold is not required for a second layer and/or a second material. FIG. 11 shows an article of apparel 1100 including a first layer 1102 and a portion of the second layer 1104. Referring to FIGS. 1 and 11, the first layer 1102 may include a dried or cured liquid material 130 and/or a plurality of fibers 140. The second layer 1104 may include dried or cured liquid material 130 and/or a plurality of fibers 150. The first layer 1102 may include a first plurality of openings and may have been formed using a first mold having a plurality of openings corresponding to the first plurality of openings. The second layer 1104 may be solid, and may have been applied over the first layer 1102 with the first mold removed and/or after the first layer 1102 has dried or cured. Although FIG. 11 illustrates that the second layer 1104 may be applied to certain areas of the first layer 1102, in some examples, the second layer 1104 may cover a continuous section and/or an entirety of the first layer 1102.

The second layer 1104 may be configured to reinforce the first layer 1102. For example, the first layer 1102 may be formed of a dried or cured liquid material and may include a plurality of openings. The plurality of openings may be arranged to provide flexibility and/or elasticity to the first layer 1102. The second layer 1104 may be formed of a same type of dried or cured liquid material, and may not include a plurality of openings so as to reinforce the first layer 1102. Alternatively or in addition thereto, the first layer 1102 may be formed of a first dried or cured liquid material, and the second layer 1104 may be formed of a second dried or cured liquid material that is less flexible and/or elastic, or more thick and/or strong, than the first dried or cured liquid material. The second layer 1104 may be referred to as a locking layer or reinforcement layer and may be configured to reduce or prevent a certain amount of movement of the first layer 1102. In some examples, the second layer 1104 may have portions that are on a same plane as the first layer 1102 and/or be integrated with the first layer 1102 (e.g., inside of the openings of the first layer 1102). The second layer 1104 may be applied to predetermined areas configured for support and/or reinforcement, such as the band portion 410 of the sports bra 400 of FIGS. 4A-4D.

FIG. 12 illustrates an example of an article of apparel 1200 including a plurality of openings 1202 and a plurality of projections 1204. The plurality of openings 1202 may vary in shape, size, and/or density. Similarly, the plurality of projections 1204 may vary in shape, size, and/or density. The plurality of projections 1204 may extend above a planar or base surface of the article of apparel 1200. In some examples, the plurality of projections 1204 may be hollow and/or include a recess at an underside facing the user when worn. The plurality of projections 1204 may be configured and/or arranged to provide breathability, stability, coverage, décor, etc. and/or to reduce irritability, abrasion, or contact between a user's skin and recesses provided on an underside of the projections 1204.

For example, the plurality of openings 1202 may a have a size that gradually decreases from a first side of the article apparel 1200 to a second side of the article of apparel 1200 and/or having a gradient pattern. The plurality of projections 1204 may a have a size that gradually decreases from the first side of the article apparel 1200 to the second side of the article of apparel 1200 and/or having a gradient pattern. The article of apparel 1200 may have been formed using a mold that similarly has a corresponding plurality of openings and a corresponding plurality of projections in a corresponding arrangement to produce the plurality of openings 1202 and the plurality of projections 1204 of the article of apparel 1200. Although FIG. 12 illustrates the article of apparel 1200, the mold may have a same shape and pattern of the plurality of openings 1202. The plurality of openings 1202 and the plurality of projections 1204 may include, for example, rows of circular holes 1202 provided between rows of conical or triangular projections, but aspects disclosed herein are not limited to an arrangement of the plurality of openings 1202 and the plurality of projections 1204.

FIGS. 13A through 13O exemplify the various types of garments and articles of apparel that may be used using the liquid spray deposition system 100, including three dimensional molds with any of the textures, holes, and/or overhangs shown in FIGS. 1-12, which may be combined with various three dimensional shapes and/or contours for a garment. In addition, any of these garments may include reinforcement elements, such as cable 460 described with reference to FIG. 4 and/or additional layers of material, such as described with reference to FIGS. 10-11, and/or other additional layers or configurations of openings for flexibility.

For example, FIG. 13A shows a T-shirt 1302 including openings near a sleeve and/or in an underarm area. The T-shirt 1302 may have been made using a three-dimensional mold in the form of the T-shirt 1302 having openings and/or overhangs. The three-dimensional mold may include the sleeves to reduce manufacturing steps. Alternatively, the sleeves may be formed using a separate cylindrical mold and coupled (e.g., sewed) on. Alternatively or in addition thereto, the front and rear sides of the T-shirt 1302 may be formed separately and later coupled together. FIG. 13B shows a T-shirt 1304 with ventilation openings in a front area. The ventilation openings may be smaller than shown, and similarly formed using a three-dimensional mold including openings and/or overhangs that correspond to the ventilation openings.

FIG. 13C shows a pair of athletic shorts 1306, which may be formed to have a plurality of openings to provide a mesh-like texture. FIG. 13D shows a baseball hat 1308 having a plurality of openings to provide ventilation to a user's head. A strap and/or bill of the hat may include a reinforcement element (e.g., cable) and/or additional or different materials.

FIG. 13E shows a shin guard 1310 having large macro openings. Alternatively or in addition thereto, the shin guard 1310 may include smaller openings. The shin guard 1310 may be formed to include a rigid or hard material.

FIG. 13F shows a wrist band 1312 including a plurality of holes to provide ventilation to a user's wrist. FIG. 13G illustrates a pair of leggings 1314 having a plurality of holes and layers of material to facilitate ventilation and/or flexibility.

FIG. 13H illustrates a cleat 1316 having a plurality of holes in varying dimensions to facilitate ventilation and/or flexibility. FIG. 13I illustrates a sweatshirt 1318 having a plurality of holes to facilitate ventilation and/or flexibility. FIG. 13J illustrates compression shorts 1320 having a plurality of holes in varying dimensions to facilitate ventilation and/or flexibility.

FIG. 13K illustrates a jacket or windbreaker 1322 having a plurality of holes to facilitate ventilation and/or flexibility. An inside of the jacket 1322 may include loft formed using the three-dimensional lattice mold of FIG. 8.

FIG. 13L illustrates a vest 1324 having a plurality of holes to facilitate ventilation and/or flexibility. FIG. 13M illustrates a tank top 1326 having a plurality of holes to facilitate ventilation and/or flexibility. FIGS. 13N and 13O illustrate gloves 1328 and 1330 having a plurality of holes to facilitate ventilation and/or flexibility.

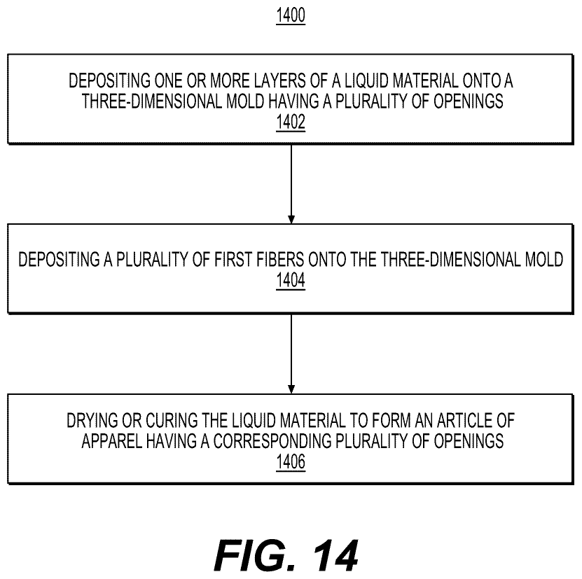

FIG. 14 illustrates a method 1400 of forming an article of apparel to have a plurality of openings. The method 1400 may include a step 1402 of applying or depositing one or more layers of a liquid material (e.g., liquid material 130) onto a three-dimensional mold having a plurality of openings. The method 1400 may include a step 1404 of depositing a plurality of fibers onto the three-dimensional mold, and the method 1400 may include a step 1406 of drying or curing the liquid material to form an article of apparel having a plurality of corresponding openings. In some examples, step 1406 may occur before step 1404, and an additional adhesive or other liquid material such as a wetting agent may be applied before the plurality of fibers are applied. In some examples, step 1406 may be omitted.

The three-dimensional mold used in method 1400 may, for example, include any of the three-dimensional molds and textures and/or any three-dimensional mold or texture configured to produce articles of apparel described with reference to FIGS. 1A through 4D and FIGS. 8A through 13O.

In some examples, the three-dimensional mold may be configured to provide insulating properties, and the article of apparel may include insulating material. The three-dimensional mold may include a lattice structure, such as the structure shown in FIGS. 8A-8B, and the resulting article of apparel may include loft configured to be inserted into a garment (e.g., a coat). The lattice structure may have a plurality of supports having a varying height that at least partially defines the plurality of openings. A size and arrangement of the plurality of openings, supports, extensions, etc. of the three-dimensional mold may be configured such that the article of insulating filler is insulating

In some examples, the three-dimensional mold may include a three-dimensional contour corresponding to a contour of the article of apparel (e.g., such as in FIGS. 2-3 and/or having a contour corresponding to the articles of apparel in FIGS. 13A-13O). At least some of the plurality of openings of the three-dimensional mold may be provided in the contour of the three-dimensional mold.

At least some of the plurality of openings may be disposed in a grid pattern in a section of the mold and a corresponding section of the article of apparel. For example, where the article of apparel is a sports bra, the plurality of openings may be disposed in a grid pattern in a band portion or section (e.g., as shown in FIGS. 3 and 4A through 4D). The three-dimensional mold may have a contour corresponding to that of a sports bra and include a body having two round protrusions protruding with respect to the band portion. The body may be considered a molded body.

In some examples, the three-dimensional mold may include a first area and a second area. The first area may be separate from the first area. A plurality of openings in the first area vary in size and/or density from a plurality of openings in the second area, and the resulting article of apparel may have resulting openings that differ in size and/or density (e.g., as shown in FIGS. 9, 12, and 13A through 13O). The plurality of openings in the three-dimensional mold may have a size, shape, and/or arrangement configured to create a plurality of macro-openings in the article of apparel for ventilation. The plurality of openings may be arranged to provide ventilation in a predetermined area or section of the three-dimensional mold to result in a plurality of openings in a predetermined area of the article of apparel.

The three-dimensional mold may include a variety of openings and protrusions to result in a variety of openings and protrusions in the resulting article of apparel. For example, the three-dimensional mold may be configured such that the article of apparel includes a plurality of macro-openings and/or slits provided between adjacent plurality of raised regions, such as shown in FIG. 12.

Step 1402 of depositing the liquid material may include spraying the liquid material using a sprayer or spray machine. The liquid may be a liquid polymer material.

Step 1402 may include depositing a first layer of a first liquid material and a second layer of a second liquid material. The first liquid material may differ from the second liquid material in at least one of elasticity or strength. In some examples, the second layer may be configured to cover or fill some of the plurality of openings formed in the first layer.

Step 1404 of depositing a plurality of fibers may include spraying or flocking a plurality of first fibers toward a first side of the three-dimensional. Step 1404 may further include spraying or flocking a plurality of second fibers toward a second side of the three-dimensional mold. The first fibers may be different from the second fibers to result in different textures.

Step 1406 may include curing the liquid material by applying heat (e.g., using ultraviolet or incandescent light or a heating coil, blowing hot air, through a chemical reaction, or by infrared radiation or by any other suitable method) and/or drying the liquid material (or allowing the liquid material to dry at, for example, ambient temperature). Step 1406 may include applying air to facilitate drying. Aspects disclosed herein are not limited to a drying process used in step 1406.

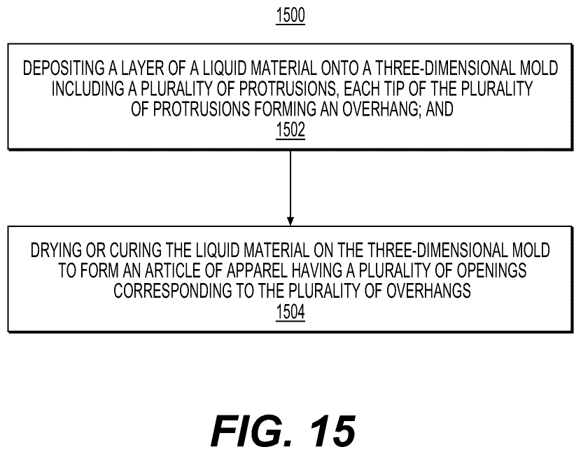

FIG. 15 illustrates a method 1500 of forming an article of apparel to have a plurality of openings using a mold that does not necessarily include a corresponding plurality of openings. Referring to FIG. 15, the method 1500 may include a step 1502 of depositing a layer of liquid material onto a three-dimensional mold. The three-dimensional mold may include a plurality of protrusions. Each tip of each protrusion may form an overhang. The method 1500 may include a step 1504 of drying or curing the liquid material onto the three-dimensional mold to form an article of apparel that includes a plurality of openings that correspond to the plurality of overhangs.

The three-dimensional mold may include a base surface, and each tip may form an overhang over the base surface. For example, the three-dimensional mold may include the mold shown in FIGS. 5A-5C. The resulting article of apparel may be used for a shoe upper.

In some examples, the three-dimensional mold may include the protrusions has a texture, and may further include a three-dimensional contour corresponding to a contour of an article of apparel (e.g., a sports bra, T-shirt, or any of the articles of apparel shown in FIGS. 13A through 13O). Step 1504 may include similar drying or curing techniques as step 1406 described with reference to FIG. 14 (e.g., applying heat, allowing the liquid material to dry at room temperature, etc.). Similarly, the liquid material may include a liquid polymer.

With respect to method 1400 and method 1500 described with reference to FIGS. 14 and 15, the plurality of openings of the three-dimensional mold in method 1400 and the plurality of protrusions of the three-dimensional mold in method 1500 may be broadly referred to as ventilation elements, as the openings and/or protrusions may be configured to result in a plurality of openings configured for ventilation. In some examples, method 1400 and method 1500 may be combined, and a three-dimensional mold may include both a plurality of openings and a plurality of protrusions having overhangs.

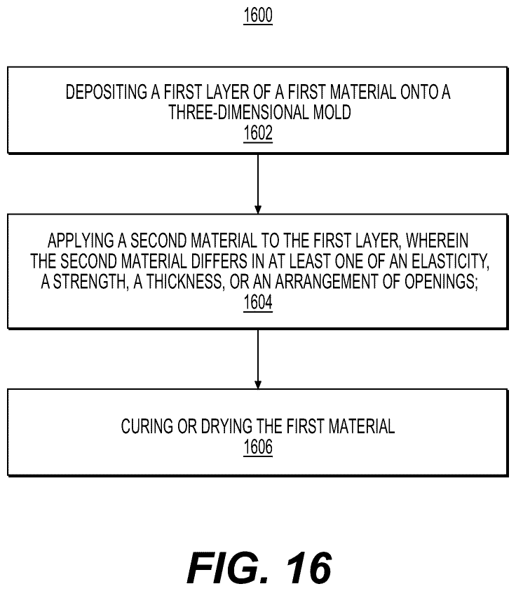

FIG. 16 illustrates a method 1600 of forming and reinforcing an article of apparel using a three-dimensional mold. The method 1600 may include a step 1602 of depositing a first layer of a first material on a three-dimensional mold, a step 1604 of applying a second material to the first layer, and a step 1606 of curing or drying the first material. The first material and the second material may differ in at least one of an elasticity, a strength, a thickness. Alternatively, the second material may be a same material as the first material and forma second layer that differs from the first layer in an arrangement of openings and/or protrusions.

Step 1604 of applying a second material may include applying a reinforcement material, such as a brio cable.

Alternatively or in addition thereto, step 1604 may include a second layer of a liquid material and/or a second layer of a fiber material. Where step 1604 includes a second layer of a liquid material, step 1606 may include drying or curing the second material. Drying or curing the second material may be performed after drying or curing the first material. The cured or dried first material and the cured or dried second material may differ in at least one of strength, elasticity, or an arrangement of a plurality of openings.

Step 1604 may include applying the second material to a portion (e.g., a reinforcement portion) of the first layer.

The three-dimensional mold may include a plurality of reinforcement elements, such as a plurality of openings and/or a plurality of overhangs, configured to result in a plurality of corresponding openings in at least the first layer. In some examples, the plurality of corresponding openings may have a grid or mesh pattern and be configured to provide a first elasticity to the first layer. Step 1604 of applying the second material may include applying a second layer of a liquid material that fills or covers at least some of the openings formed in the first layer to provide reinforcement to the first layer. The second layer may have a second elasticity that is less than the first elasticity. In some examples, the second layer may have a plurality of openings having a different arrangement (e.g., size or density) than the first layer.

The second material may be configured to form a reinforcement portion and/or a scrim at a predetermined portion of the article of apparel. For example, the second material may form a scrim at a band portion of a sports bra. As another example, the second material may be a brio cable configured to reinforce a shoe upper at positions between a plurality of slits formed by overhangs in the three-dimensional mold.

FIGS. 17A through 17L exemplify additional three-dimensional molds that may be used in the liquid spray deposition system 100 and may be combined with any of the three dimensional molds having any of the textures, contours, shapes, holes, and/or overhangs shown in FIGS. 1-12.

The following clauses provide an exemplary configuration for three-dimensional molds and methods using the same in a liquid spray deposition system described above.

Clause 1. A method of manufacturing an article of apparel, comprising: depositing a first layer of a first liquid material onto a three-dimensional mold, wherein the three-dimensional mold includes a plurality of openings, wherein the plurality of openings in the three-dimensional mold are sized and arranged such that the article of apparel includes a plurality of openings corresponding to the plurality of openings in the three-dimensional mold, wherein the three-dimensional mold includes a varying height that at least partially defines a size of the plurality of openings; and drying or curing the first liquid material on the three-dimensional mold to form the article of apparel.

Clause 2. The method of clause 1, wherein the three-dimensional mold includes a lattice structure and the article of apparel includes an insulating material.

Clause 3. The method of clause 2, wherein the lattice structure includes supports having a varied height, and the plurality of openings are at least partially defined by the supports.

Clause 4. The method of clause 1, wherein the three-dimensional mold includes a three-dimensional contour corresponding to a contour of the article of apparel, and at least some of the plurality of openings of the three-dimensional mold are provided in the contour of the three-dimensional mold.

Clause 5. The method of clause 4, wherein at least some of the plurality of openings of the article of apparel are disposed in a grid pattern in a band of the article of apparel.

Clause 6. The method of clause 1, further comprising coupling a brio cable to the article of apparel.

Clause 7. The method of clause 1, further comprising spraying or flocking a plurality of first fibers to a first side of the three-dimensional mold.

Clause 8. The method of clause 7, further comprising spraying or flocking a plurality of second fibers to a second side of the three-dimensional mold, and wherein the first fibers are different from the second fibers.

Clause 9. The method of clause 1, further comprising depositing a second layer of a second liquid material on at least a portion of the three-dimensional mold.

Clause 10. The method of clause 9, wherein the first liquid material differs from the second liquid material in at least one of elasticity or strength.

Clause 11. The method of clause 9, wherein the second layer of the second liquid material is configured to cover a plurality of openings formed in the first layer of the first liquid material.

Clause 12. The method of clause 1, wherein the three-dimensional mold includes a first area and a second area, wherein the first area is separate from the first area, and wherein a plurality of openings in the first area vary in size and/or density from a plurality of openings in the second area.

Clause 13. The method of clause 1, further comprising applying a layer of a reinforcement material to a portion of the first layer, wherein the reinforcement material is a second liquid material or a fiber material.

Clause 14. The method of clause 1, wherein drying or curing the first liquid material includes curing the first liquid material by applying heat.

Clause 15. The method of clause 1, wherein drying or curing the first liquid material includes drying the first liquid material at room temperature.

Clause 30. The three-dimensional mold of clause 29, wherein the base surface includes a contour configured to provide a corresponding contour in the three-dimensional article of apparel.

Clause 31. The three-dimensional mold of clause 29, wherein the three-dimensional mold is a rigid material.

Clause 32. The three-dimensional mold of clause 31, wherein the rigid material is plastic, ceramic, or metal.

Clause 33. The three-dimensional mold of clause 29, wherein at least a portion of the opening is based on a total height of the protrusion.

Clause 34. The three-dimensional mold of clause 29, wherein the tip or the edge of each protrusion is curved.

Clause 35. A three-dimensional article of apparel formed by depositing a liquid polymer on the three-dimensional mold of any one of clauses 29 through 34.

Clause 36. A three-dimensional mold for forming a three-dimensional article of insulating filler, the three-dimensional mold comprising: a body having a three-dimensional lattice structure defining a plurality of openings, wherein the body has a height that varies to at least partially define the plurality of openings, and a size and arrangement of the plurality of openings is configured such that the article of insulating filler is insulating.

Clause 37. A three-dimensional article of insulating filler formed by depositing a liquid polymer on the three-dimensional mold of clause 36.

Clause 38. A three-dimensional article of apparel, comprising: a body comprising a cured or dried first polymer material, wherein the body includes a three-dimensional contour; and a plurality of macro-openings provided in a predetermined area of the body, wherein the plurality of macro-openings and the predetermined area are configured to provide ventilation.

Clause 39. The three-dimensional article of apparel of clause 38, further comprising a fiber material coupled to the cured or dried first polymer material.

Clause 40. The three-dimensional article of apparel of clause 38, further comprising a cured or dried second polymer material provided over the cured or dried first polymer material.

Clause 41. The three-dimensional article of apparel of clause 40, wherein the cured or dried first polymer material and the cured or dried second polymer material differ in at least one of strength, elasticity, or an arrangement of a plurality of openings.

Clause 42. The three-dimensional article of apparel of clause 38, wherein the body defines a bra, and the plurality of macro-openings are provided in a band of the bra.

Clause 43. The three-dimensional article of apparel of clause 38, wherein the body defines a bra, and a band of the bra includes a cured or dried second polymer material.

Clause 44. The three-dimensional article of apparel of clause 38, wherein the article of apparel includes a plurality of raised regions, and the plurality of macro-openings include a plurality of slits provided between adjacent plurality of raised regions.

Clause 45. The three-dimensional article of apparel of clause 38, further comprising at least one brio cable.

Clause 46. A method of manufacturing a three-dimensional article of apparel having a reinforcement portion, comprising: depositing a first layer of a first material onto a three-dimensional mold, wherein the first material is a liquid polymer, wherein the three-dimensional mold has a contour corresponding to a contour of the article of apparel, and wherein the three-dimensional mold includes a plurality of openings configured to form a plurality of corresponding openings in the first layer; applying a second material to the first layer, wherein the second material differs in at least one of an elasticity, a strength, a thickness, or an arrangement of openings; and curing or drying the first material.

Clause 47. The method of clause 46, wherein the three-dimensional mold includes a plurality of protrusions, and the first layer includes a plurality of protrusions corresponding to the plurality of protrusions in the three-dimensional mold.

Clause 48. The method of clause 46, wherein applying the second material includes applying a second layer of the liquid polymer, wherein the second layer covers the plurality of openings in the first layer.

Clause 49. The method of clause 46, wherein the second material includes a fiber material.

Clause 50. The method of clause 46, wherein the second material is configured to form a scrim at a band portion of the article of apparel.

Clause 51. An article of apparel formed using the method of any one of clauses 46 through 50.

Clause 52. A three-dimensional article of apparel including a reinforcement portion, comprising: a first material including a cured or dried polymer, wherein the first material includes a first layer, a three-dimensional contour configured to provide support; and a second material applied to the first material and configured to provide reinforcement to the first layer at the reinforcement portion, the second material differs from the first material in at least one of elasticity, strength, an arrangement of protrusions, or an arrangement of openings.

Clause 53. The three-dimensional article of apparel of clause 52, wherein the second material is a second layer or material that is distinct from the first layer of material.

Clause 54. The three-dimensional article of apparel of clause 53, wherein the second layer forms a scrim.

Clause 55. The three-dimensional article of apparel of clause 53, wherein the second layer includes a cured or dried polymer.

Clause 56. The three-dimensional article of apparel of clause 53, wherein the second layer includes a fiber material.

Clause 57. The three-dimensional article of apparel of clause 53, wherein the first layer includes a plurality of openings and has an elasticity that is greater than an elasticity of the second layer.

Clause 58. The three-dimensional garment of clause 57, wherein the plurality of openings are arranged to form a mesh design.

Clause 59. The three-dimensional garment of clause 57, wherein the second material covers the plurality of openings in the first layer.

Clause 60. The three-dimensional garment of clause 53, wherein the second layer includes a plurality of openings.

Clause 61. The three-dimensional garment of clause 52, wherein the second material includes at least one brio cable.

Clause 62. The three-dimensional garment of clause 52, wherein the first layer includes a plurality of openings, wherein a size, shape, and/or density of the plurality of openings varies.

Clause 63. The three-dimensional garment of clause 52, wherein the first layer includes a plurality of protrusions, wherein a size, shape, and/or density of the plurality of protrusions varies.

Clause 64. The three-dimensional garment of clause 52, wherein the contour includes a band and two rounded protrusions that protrude with respect to the band such that the three-dimensional article of apparel is a bra, and the reinforcement portion includes the band.

Clause 65. An article of apparel, comprising: a first material including a cured or dried liquid polymer, wherein the first material defines a first layer, wherein the first layer includes a plurality of openings arranged in a grid pattern, the plurality of openings formed by spraying the liquid polymer onto a mold including a plurality of corresponding openings, and wherein the first layer includes a first elasticity; and a second material defining a second layer, wherein the second layer was sprayed or flocked over the first layer to cover the plurality of openings in the first layer, and wherein the second material includes a second elasticity that is less than the first elasticity.

Clause 66. A mold for forming at least a portion of an article of apparel, the mold comprising: a base surface; and a plurality of protrusions, each protrusion extending in a direction away from the base surface to a tip or an edge of the respective protrusion, wherein at least one protrusion includes at least one side face having a negative draft angle.

Clause 67. The mold of clause 66, wherein each protrusion further includes a top surface, the top surface having a thickness greater than the base surface of the mold or the at least one side face of the protrusion.

Clause 68. The mold of clause 66, wherein the at least one side face is curved or angled.

Clause 69. An three-dimensional article of apparel, the article of apparel comprising: a molded body comprising a cured or dried first polymer material; and a plurality of molded venting structures provided in a predetermined area of the molded body, each molded venting structure extending away from the molded body including an edge, wherein at least one of the plurality of molded venting structures comprises an opening along its respective edge.

Clause 70. The article of apparel of clause 69, wherein the opening is a fraction of a total length of the edge.

Clause 71. The article of apparel of clause 69, wherein the opening is equal to a total length of the edge.

Clause 72. A three-dimensional article of apparel, the three-dimensional article of apparel comprising: a body comprising a cured or dried first polymer material, wherein the body includes a three-dimensional contour; and a plurality of openings provided within the body, wherein the plurality of openings are configured to provide ventilation.

Clause 73. The three-dimensional article of apparel of clause 72, wherein the first polymer material is a thermoplastic polymer.

Clause 74. The three-dimensional article of apparel of clause 72, wherein each of the plurality of openings has a dimension of at least 0.5 mm.

Clause 75. The three-dimensional article of apparel of clause 74, wherein the plurality of openings are arranged in multiple columns and/or multiple rows.

Clause 76. The three-dimensional article of apparel of clause 74, wherein the plurality of openings includes at least 20 openings.

Clause 77. The three-dimensional article of apparel of clause 72, further comprising a plurality of protuberances, wherein each protuberance of the plurality of protuberances includes an opening of the plurality of openings.

Clause 78. The three-dimensional article of apparel of clause 77, wherein each of the plurality of protuberances includes a curvature that facilitates drainage.

Clause 79. The three-dimensional article of apparel of clause 77, wherein each of the plurality of protuberances includes a convex curvature extending away from the body.

Clause 80. The three-dimensional article of apparel of clause 77, wherein each of the plurality of protuberances includes a round shape having a peripheral edge, and wherein the peripheral edge includes the opening of the plurality of openings.

Clause 81. The three-dimensional article of apparel of clause 72, wherein the body is a molded body.

Clause 82. The three-dimensional article of apparel of clause 81, further comprising a plurality of protuberances, wherein each opening of the plurality of openings is included in a respective protuberance of the plurality of protuberances, and wherein the plurality of protuberances are molded protuberances integrally formed with the body.

Clause 83. The three-dimensional article of apparel of clause 81, wherein each of the plurality of openings includes a dimension that is larger than a droplet size of the liquid material.

Clause 84. The three-dimensional article of apparel of clause 72, further comprising a fiber material coupled to the cured or dried first polymer material.

Clause 85. The three-dimensional article of apparel of clause 72, further comprising a reinforcement element.

Clause 86. An article of apparel, the article of apparel comprising: a first material including a cured or dried first liquid polymer and defining a first layer comprising a first surface and a second surface opposite the first surface, wherein the first layer includes a first plurality of openings; and a second material at least partially embedded onto one or more of the first surface and the second surface, wherein each of the first plurality of openings is formed within a respective plurality of protuberances extending away from the first surface.

Clause 87. The article of apparel of clause 86, wherein the first material includes a first elasticity and the second material includes a second elasticity that is less than the first elasticity.

Clause 88. The article of apparel of clause 86, wherein the second material includes a cured or dried second polymer material provided over the cured or dried first liquid polymer.

Clause 89. The article of apparel of clause 86, wherein the first layer comprises a second plurality of openings, and wherein each of the second plurality of openings are smaller in size than each of the first plurality of openings.

Clause 90. The article of apparel of clause 86, wherein a thickness of the protuberances varies in a direction of the extension of the protuberances away from the first surface.

Clause 91. An article of apparel, the article of apparel comprising: a first material including a cured or dried polymer, wherein the first material includes a first layer; and a second material applied to the first material and configured to provide reinforcement to the first layer, wherein the second material differs from the first material in elasticity and/or tensile strength.

Clause 92. The article of apparel of clause 91, wherein the second material is included in a cable.

Clause 93. The article of apparel of clause 91, wherein the first layer includes a plurality of openings and wherein the second material covers at least some of the plurality of openings in the first layer.

We claim:

1. A three-dimensional article of apparel, comprising:
a body comprising a cured or dried first polymer material, wherein the body includes a three-dimensional contour; and
a plurality of openings provided within the body, wherein the plurality of openings are configured to provide ventilation.

2. The three-dimensional article of apparel of claim 1, wherein the first polymer material is a thermoplastic polymer.

3. The three-dimensional article of apparel of claim 1, wherein each of the plurality of openings has a dimension of at least 0.5 mm.

4. The three-dimensional article of apparel of claim 3, wherein the plurality of openings are arranged in multiple columns and/or multiple rows.

5. The three-dimensional article of apparel of claim 1, further comprising a plurality of protuberances, wherein each protuberance of the plurality of protuberances includes an opening of the plurality of openings.

6. The three-dimensional article of apparel of claim 5, wherein each of the plurality of protuberances includes a curvature that facilitates drainage.

7. The three-dimensional article of apparel of claim 5, wherein each of the plurality of protuberances includes a convex curvature extending away from the body.

8. The three-dimensional article of apparel of claim 5, wherein each of the plurality of protuberances includes a round shape having a peripheral edge, and wherein the peripheral edge includes the opening of the plurality of openings.

9. The three-dimensional article of apparel of claim 1, wherein the body is a molded body.

10. The three-dimensional article of apparel of claim 9, further comprising a plurality of protuberances, wherein each opening of the plurality of openings is included in a respective protuberance of the plurality of protuberances, and wherein the plurality of protuberances are molded protuberances integrally formed with the body.

11. The three-dimensional article of apparel of claim 1, further comprising a fiber material coupled to the cured or dried first polymer material.

12. The three-dimensional article of apparel of claim 1, further comprising a reinforcement element.

13. An article of apparel, comprising:
a first material including a cured or dried first liquid polymer and defining a first layer comprising a first surface and a second surface opposite the first surface, wherein the first layer includes a first plurality of openings; and
a second material at least partially embedded onto one or more of the first surface and the second surface,
wherein each of the first plurality of openings is formed within a respective plurality of protuberances extending away from the first surface.

14. The article of apparel of claim 13, wherein the first material includes a first elasticity and the second material includes a second elasticity that is less than the first elasticity.

15. The article of apparel of claim 13, wherein the second material includes a cured or dried second polymer material provided over the cured or dried first liquid polymer.

16. The article of apparel of claim 13, wherein the first layer comprises a second plurality of openings, and wherein each of the second plurality of openings are smaller in size than each of the first plurality of openings.

17. The article of apparel of claim 13, wherein a thickness of the protuberances varies in a direction of the extension of the protuberances away from the first surface.

18. An article of apparel, comprising:
a first material including a cured or dried polymer, wherein the first material includes a first layer; and
a second material applied to the first material and configured to provide reinforcement to the first layer, wherein the second material differs from the first material in elasticity and/or tensile strength.

19. The article of apparel of claim 18, wherein the second material is included in a cable.

20. The article of apparel of claim 18, wherein the first layer includes a plurality of openings and wherein the second material covers at least some of the plurality of openings in the first layer.
